(19) United States
(12) Patent Application Publication
(10) Pub. No.: US 2024/0077623 A1
(43) Pub. Date: Mar. 7, 2024

(54) HOST VEHICLE POSITION MEASURING DEVICE AND HOST VEHICLE POSITION MEASURING METHOD

(71) Applicant: Mitsubishi Electric Corporation, Tokyo (JP)

(72) Inventors: Takefumi HASEGAWA, Tokyo (JP); Kyosuke Konishi, Tokyo (JP)

(73) Assignee: Mitsubishi Electric Corporation, Tokyo (JP)

(21) Appl. No.: 18/349,382

(22) Filed: Jul. 10, 2023

(30) Foreign Application Priority Data
Sep. 1, 2022 (JP) 2022-138884

(51) Int. Cl. G01S 19/48; G01C 21/00; G01S 19/40; G06V 20/56

(52) U.S. Cl. CPC G01S 19/485; G01C 21/3848; G01S 19/40; G06V 20/56

(57) ABSTRACT

Host vehicle position measuring accuracy can be improved even in a situation where a position of a feature present around the host vehicle cannot be detected on the basis of sensor information from an in-vehicle sensor. A host vehicle position measuring device is configured to include: a host vehicle position measuring unit that measures a position of a host vehicle using a satellite signal emitted from a satellite positioning system; and a position correcting unit that estimates, using an error estimating model for estimating a position measuring error in the host vehicle position measuring unit, a measuring error corresponding to the position of the host vehicle measured by the host vehicle position measuring unit, and corrects the position of the host vehicle measured by the host vehicle position measuring unit using the measuring error.

### TECHNICAL FIELD

The present disclosure relates to a host vehicle position measuring device and a host vehicle position measuring method.

### BACKGROUND ART

There is a host vehicle position measuring device that measures a position of a host vehicle (see, for example, Patent Literature 1). The host vehicle position measuring device includes a coordinate acquiring unit, a recognition unit, and a control unit.

The coordinate acquiring unit measures a position of a host vehicle on the basis of a radio wave coming from a satellite and acquires the position coordinates of the host vehicle. The recognition unit acquires lane information indicating a lane of a road on which the host vehicle travels and recognizes a distance between the lane and the host vehicle on the basis of the lane information. The control unit corrects the position coordinates of the host vehicle acquired by the coordinate acquiring unit on the basis of the distance recognized by the recognition unit.

### CITATION LIST

### Patent Literature

Patent Literature 1: JP 2017-211193 A

### SUMMARY OF INVENTION

### Technical Problem

In the host vehicle position measuring device disclosed in Patent Literature 1, for example, in a case where a lane is not displayed on a road or in a case where display of a lane displayed on a road is dimmed, the recognition unit cannot acquire lane information in some cases. There is a problem that the control unit cannot improve position measuring accuracy by correcting position coordinates of a host vehicle acquired by the coordinate acquiring unit unless the lane information is acquired by the recognition unit.

The present disclosure has been made in order to solve the above problem, and an object of the present disclosure is to provide a host vehicle position measuring device capable of improving host vehicle position measuring accuracy even in a situation where a position of a feature present around the host vehicle cannot be detected, on the basis of sensor information from an in-vehicle sensor.

### Solution to Problem

A host vehicle position measuring device according to the present disclosure includes: processing circuitry configured to measure a position of a host vehicle using a satellite signal emitted from a satellite positioning system; and estimate, using an error estimating model for estimating a position measuring error, a measuring error corresponding to the measured position of the host vehicle, and correct the measured position of the host vehicle using the measuring error.

### Advantageous Effects of Invention

According to the present disclosure, host vehicle position measuring accuracy can be improved even in a situation where a position of a feature present around the host vehicle cannot be detected, on the basis of sensor information from an in-vehicle sensor.

### BRIEF DESCRIPTION OF DRAWINGS

FIG. 1 is a configuration diagram illustrating a host vehicle position measuring device 3 according to a first embodiment.

FIG. 2 is a hardware configuration diagram illustrating hardware of the host vehicle position measuring device 3 according to the first embodiment.

FIG. 3 is a hardware configuration diagram of a computer in a case where the host vehicle position measuring device 3 is implemented by software, firmware, or the like.

FIG. 4 is a flowchart illustrating a host vehicle position measuring method which is a processing procedure performed in the host vehicle position measuring device 3.

FIG. 5 is an explanatory diagram illustrating an example of detection of a white line by a first feature position detecting unit 11.

FIG. 6 is an explanatory diagram illustrating an example of detection of a white line by a second feature position detecting unit 13.

FIG. 7A is an explanatory diagram illustrating a relative position detected by the first feature position detecting unit 11, FIG. 7B is an explanatory diagram illustrating a relative position detected by the second feature position detecting unit 13, and FIG. 7C is an explanatory diagram illustrating an error calculated by an error calculating unit 14.

FIG. 8 is an explanatory diagram illustrating a recurrent neural network that implements a learning model 15a.

FIG. 9 is an explanatory diagram illustrating a travel section in which the first feature position detecting unit 11 can detect a relative position of a feature and a travel section in which the first feature position detecting unit 11 cannot detect the relative position of the feature.

FIG. 10 is a configuration diagram illustrating a host vehicle position measuring device 3 according to a second embodiment.

FIG. 11 is a hardware configuration diagram illustrating hardware of the host vehicle position measuring device 3 according to the second embodiment.

FIG. 12 is an explanatory diagram illustrating an example of a state space model 17a.

FIG. 13 is a configuration diagram illustrating a host vehicle position measuring device 3 according to a third embodiment.

FIG. 14 is a hardware configuration diagram illustrating hardware of the host vehicle position measuring device 3 according to the third embodiment.

FIG. 15 is an explanatory diagram illustrating an example of an approximate function indicating a measuring error Y corresponding to a time t.

FIG. 16 is a configuration diagram illustrating a host vehicle position measuring device 3 according to a fourth embodiment.

FIG. 17 is a hardware configuration diagram illustrating hardware of the host vehicle position measuring device 3 according to the fourth embodiment.

FIG. 18 is an explanatory diagram illustrating an example of a measuring error calculated by a position correcting unit 20.

FIG. 19 is a configuration diagram illustrating a host vehicle position measuring device 3 according to a fifth embodiment.

FIG. 20 is a hardware configuration diagram illustrating hardware of the host vehicle position measuring device 3 according to the fifth embodiment.

FIG. 21 is an explanatory diagram illustrating a change in a position of the host vehicle measured by the host vehicle position measuring unit 12.

FIG. 22 is a configuration diagram illustrating a host vehicle position measuring device 3 according to a sixth embodiment.

FIG. 23 is a hardware configuration diagram illustrating hardware of the host vehicle position measuring device 3 according to the sixth embodiment.

FIG. 24A is an explanatory diagram illustrating a travel environmental condition with few obstacles. FIG. 24B is an explanatory diagram illustrating a travel environmental condition with many obstacles.

### DESCRIPTION OF EMBODIMENTS

Hereinafter, in order to describe the present disclosure in more detail, embodiments for carrying out the present disclosure will be described with reference to the attached drawings.

### First Embodiment

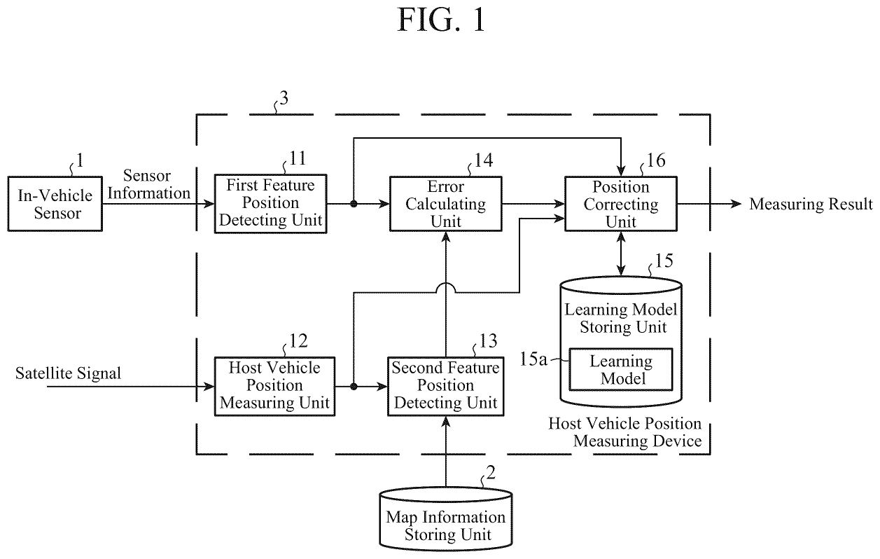

FIG. 1 is a configuration diagram illustrating a host vehicle position measuring device 3 according to a first embodiment.

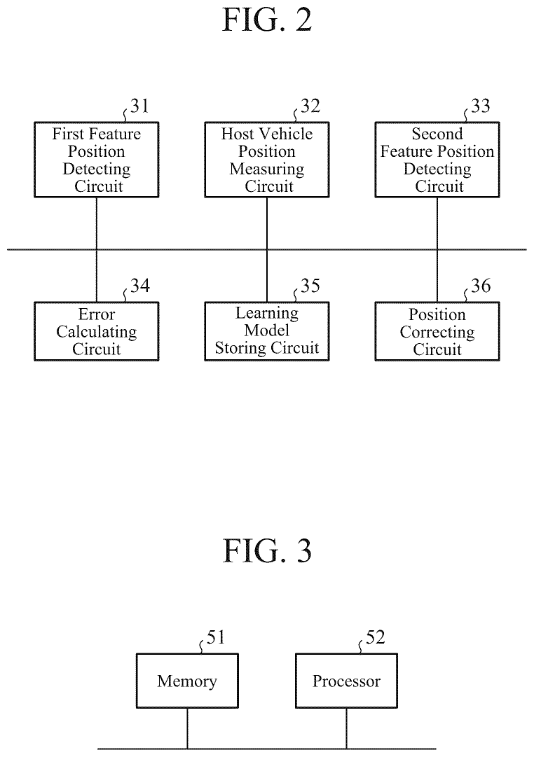

FIG. 2 is a hardware configuration diagram illustrating hardware of the host vehicle position measuring device 3 according to the first embodiment.

In FIG. 1, an in-vehicle sensor 1 includes, for example, a camera, a light detection and ranging (LiDAR), a millimeter wave sensor, or a sonar.

The in-vehicle sensor 1 observes surroundings of a host vehicle and outputs sensor information indicating an observation result of the surroundings to the host vehicle position measuring device 3.

A map information storing unit 2 is implemented by, for example, a hard disk or a random access memory (RAM).

The map information storing unit 2 stores map information.

The host vehicle position measuring device 3 includes a first feature position detecting unit 11, a host vehicle position measuring unit 12, a second feature position detecting unit 13, an error calculating unit 14, a learning model storing unit 15, and a position correcting unit 16.

The host vehicle position measuring device 3 measures a position of the host vehicle using the sensor information from the in-vehicle sensor 1 and a satellite signal from a satellite positioning system.

The first feature position detecting unit 11 is implemented by, for example, a first feature position detecting circuit 31 illustrated in FIG. 2.

The first feature position detecting unit 11 acquires the sensor information from the in-vehicle sensor 1.

The first feature position detecting unit 11 detects a relative position of a feature present around the host vehicle with respect to the host vehicle (hereinafter, referred to as “relative position of a feature”) on the basis of the sensor information. Examples of the feature include a white line on a road on which the host vehicle is traveling, a side wall of the road on which the host vehicle is traveling, and a signboard disposed on the road on which the host vehicle is traveling.

The first feature position detecting unit 11 outputs first feature position data to each of the error calculating unit 14 and the position correcting unit 16 as position data indicating the relative position of the feature.

The host vehicle position measuring unit 12 is implemented by, for example, a host vehicle position measuring circuit 32 illustrated in FIG. 2.

The host vehicle position measuring unit 12 includes a receiver that receives a satellite signal emitted from a satellite positioning system.

The host vehicle position measuring unit 12 measures the position of the host vehicle using the satellite signal.

The host vehicle position measuring unit 12 outputs host vehicle position data to each of the second feature position detecting unit 13 and the position correcting unit 16 as position data indicating the position of the host vehicle.

The second feature position detecting unit 13 is implemented by, for example, a second feature position detecting circuit 33 illustrated in FIG. 2.

The second feature position detecting unit 13 acquires the host vehicle position data from the host vehicle position measuring unit 12, and acquires map information from the map information storing unit 2.

The second feature position detecting unit 13 detects a relative position of a feature on the basis of the position of the host vehicle indicated by the host vehicle position data and the map information.

The second feature position detecting unit 13 outputs second feature position data to the error calculating unit 14 as position data indicating the relative position of the feature.

The error calculating unit 14 is implemented by, for example, an error calculating circuit 34 illustrated in FIG. 2.

The error calculating unit 14 calculates an error between the relative position of the feature detected by the first feature position detecting unit 11 and the relative position of the feature detected by the second feature position detecting unit 13.

The error calculating unit 14 outputs error data indicating the calculated error to the position correcting unit 16.

The learning model storing unit 15 is implemented by, for example, a learning model storing circuit 35 illustrated in FIG. 2.

The learning model storing unit 15 stores a learning model 15a as an error estimating model for estimating a position measuring error in the host vehicle position measuring unit 12.

The learning model 15a is implemented by, for example, a recurrent neural network capable of receiving time-series data. Examples of the recurrent neural network include a recurrent neural network (RNN) and a long short term memory (LSTM).

At the time of learning of the learning model 15a, learning data is supplied to an input layer of the recurrent neural network. The learning data includes the host vehicle position data output from the host vehicle position measuring unit 12 and the error data output from the error calculating unit 14. The error data is used as teacher data, and the learning model 15a learns a measuring error using an error indicated by the error data as the measuring error.

At the time of estimating the measuring error, the host vehicle position data output from the host vehicle position measuring unit 12 is supplied to the input layer of the recurrent neural network. As a result, measuring error data indicating a measuring error corresponding to the host vehicle position data is output from an output layer of the recurrent neural network.

Here, an example is illustrated in which the learning model 15a is implemented by the recurrent neural network. However, this is merely an example, and the learning model 15a may be implemented by a general neural network.

The position correcting unit 16 is implemented by, for example, a position correcting circuit 36 illustrated in FIG. 2.

The position correcting unit 16 estimates, using an error estimating model for estimating a position measuring error in the host vehicle position measuring unit 12, a measuring error corresponding to the position of the host vehicle measured by the host vehicle position measuring unit 12.

Specifically, the position correcting unit 16 supplies the host vehicle position data indicating the position of the host vehicle measured by the host vehicle position measuring unit 12 to the learning model 15a, and acquires measuring error data indicating a measuring error corresponding to the position indicated by the host vehicle position data from the learning model 15a.

The position correcting unit 16 corrects the position of the host vehicle measured by the host vehicle position measuring unit 12 using the measuring error indicated by the measuring error data.

The position correcting unit 16 may correct the position of the host vehicle at all times using the measuring error, but as described below, the position correcting unit 16 may correct the position of the host vehicle using the measuring error only when a reliability R of position detection performed by the first feature position detecting unit 11 is smaller than an allowable reliability TR. In this case, when the reliability R is equal to or larger than the allowable reliability TR, the position correcting unit 16 causes the learning model 15a to learn the measuring error.

Specifically, the position correcting unit 16 calculates the reliability R of position detection performed by the first feature position detecting unit 11.

When the reliability R of position detection performed by the first feature position detecting unit 11 is equal to or larger than the allowable reliability TR, the position correcting unit 16 supplies learning data to the learning model 15a. The learning data includes the host vehicle position data indicating the position of the host vehicle measured by the host vehicle position measuring unit 12 and the error data indicating the error calculated by the error calculating unit 14.

The position correcting unit 16 causes the learning model 15a to learn the measuring error using the error indicated by the error data included in the learning data as the measuring error.

When the reliability R of position detection performed by the first feature position detecting unit 11 is smaller than the allowable reliability TR, the position correcting unit 16 supplies the host vehicle position data indicating the position of the host vehicle measured by the host vehicle position measuring unit 12 to the learning model 15a, and acquires measuring error data indicating a measuring error corresponding to the position indicated by the host vehicle position data from the learning model 15a.

The position correcting unit 16 corrects the position of the host vehicle measured by the host vehicle position measuring unit 12 using the measuring error indicated by the measuring error data.

When the reliability R of position detection performed by the first feature position detecting unit 11 is equal to or larger than the allowable reliability TR, the position correcting unit 16 outputs, as a position measuring result, the host vehicle position data indicating the position of the host vehicle measured by the host vehicle position measuring unit 12 to, for example, an automatic driving system.

When the reliability R of position detection performed by the first feature position detecting unit 11 is smaller than the allowable reliability TR, the position correcting unit 16 outputs, as a position measuring result, corrected position data indicating the corrected position to, for example, the automatic driving system.

The automatic driving system controls the host vehicle in such a manner that the host vehicle travels in a road lane on the basis of the position of the host vehicle measured by the host vehicle position measuring device 3.

In FIG. 1, it is assumed that each of the first feature position detecting unit 11, the host vehicle position measuring unit 12, the second feature position detecting unit 13, the error calculating unit 14, the learning model storing unit 15, and the position correcting unit 16, which are constituent elements of the host vehicle position measuring device 3, is implemented by dedicated hardware as illustrated in FIG. 2. That is, it is assumed that the host vehicle position measuring device 3 is implemented by the first feature position detecting circuit 31, the host vehicle position measuring circuit 32, the second feature position detecting circuit 33, the error calculating circuit 34, the learning model storing circuit 35, and the position correcting circuit 36.

Here, to the learning model storing circuit 35, for example, a nonvolatile or volatile semiconductor memory such as RAM, read only memory (ROM), flash memory, erasable programmable read only memory (EPROM), or electrically erasable programmable read-only memory (EEPROM), a magnetic disk, a flexible disk, an optical disc, a compact disc, a mini disc, or a digital versatile disc (DVD) corresponds.

To each of the first feature position detecting circuit 31, the host vehicle position measuring circuit 32, the second feature position detecting circuit 33, the error calculating circuit 34, and the position correcting circuit 36, a single circuit, a composite circuit, a programmed processor, a parallel programmed processor, an application specific integrated circuit (ASIC), a field-programmable gate array (FPGA), or a combination thereof corresponds.

The constituent elements of the host vehicle position measuring device 3 are not limited to those implemented by dedicated hardware, and the host vehicle position measuring device 3 may be implemented by software, firmware, or a combination of software and firmware.

Software or firmware is stored as a program in a memory of a computer. The computer means hardware for executing a program. To the computer, for example, a central processing unit (CPU), a central processing device, a processing device, an arithmetic device, a microprocessor, a microcomputer, a processor, or a digital signal processor (DSP) corresponds.

FIG. 3 is a hardware configuration diagram of a computer in a case where the host vehicle position measuring device 3 is implemented by software, firmware, or the like.

In a case where the host vehicle position measuring device 3 is implemented by software, firmware, or the like, the learning model storing unit 15 is constituted on a memory 51 of the computer. A program for causing the computer to execute a processing procedure performed in each of the first feature position detecting unit 11, the host vehicle position measuring unit 12, the second feature position detecting unit 13, the error calculating unit 14, and the position correcting unit 16 is stored in the memory 51. A processor 52 of the computer executes the program stored in the memory 51.

FIG. 2 illustrates an example in which each of the constituent elements of the host vehicle position measuring device 3 is implemented by dedicated hardware, and FIG. 3 illustrates an example in which the host vehicle position measuring device 3 is implemented by software, firmware, or the like. However, this is only an example, and some constituent elements in the host vehicle position measuring device 3 may be implemented by dedicated hardware, and the remaining constituent elements may be implemented by software, firmware, or the like.

Next, an operation of the host vehicle position measuring device 3 illustrated in FIG. 1 will be described.

The in-vehicle sensor 1 observes surroundings of a host vehicle and outputs sensor information indicating an observation result of the surroundings to the host vehicle position measuring device 3.

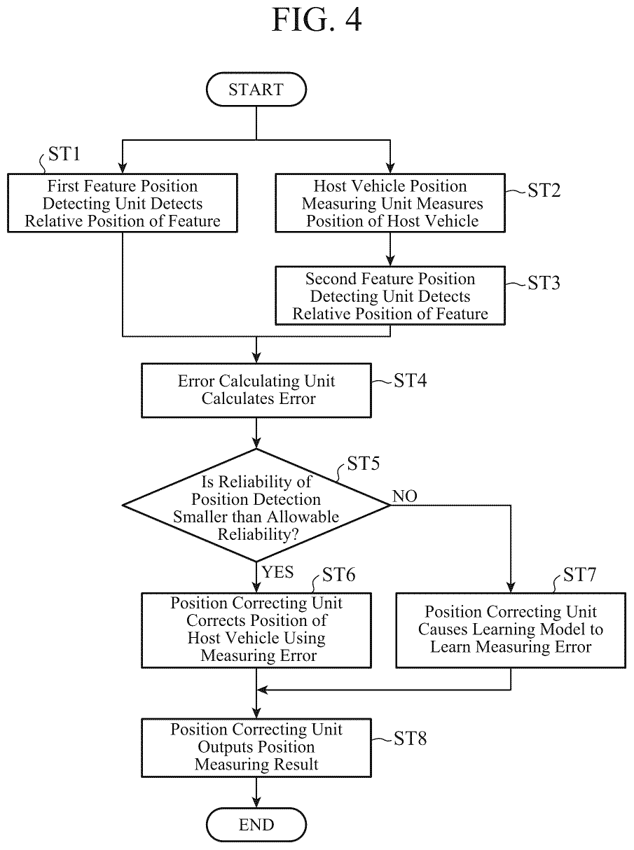

FIG. 4 is a flowchart illustrating a host vehicle position measuring method which is a processing procedure performed in the host vehicle position measuring device 3.

The first feature position detecting unit 11 of the host vehicle position measuring device 3 acquires the sensor information from the in-vehicle sensor 1.

The first feature position detecting unit 11 detects a relative position of a feature present around the host vehicle on the basis of the sensor information (step ST1 in FIG. 4).

In a case where the first feature position detecting unit 11 detects a relative position of a white line on a road with respect to the host vehicle as the relative position of the feature, for example, the first feature position detecting unit 11 detects the relative position of the white line by extracting a white line portion from an image captured by a camera included in the in-vehicle sensor 1. Alternatively, the first feature position detecting unit 11 detects the relative position of the white line by extracting the white line portion from reflection intensity information of a measurement point group in LiDAR included in the in-vehicle sensor 1.

In a case where the first feature position detecting unit 11 detects a relative position of a side wall of a road with respect to the host vehicle as the relative position of the feature, for example, the first feature position detecting unit 11 detects the relative position of the side wall from a reflected wave from the side wall received by a millimeter wave sensor included in the in-vehicle sensor 1.

In a case where the first feature position detecting unit 11 detects a relative position of a signboard with respect to the host vehicle as the relative position of the feature, for example, the first feature position detecting unit 11 detects the relative position of the signboard by performing image processing of specifying the signboard appearing in an image captured by a camera included in the in-vehicle sensor 1.

The first feature position detecting unit 11 outputs the first feature position data indicating the relative position of the feature to each of the error calculating unit 14 and the position correcting unit 16.

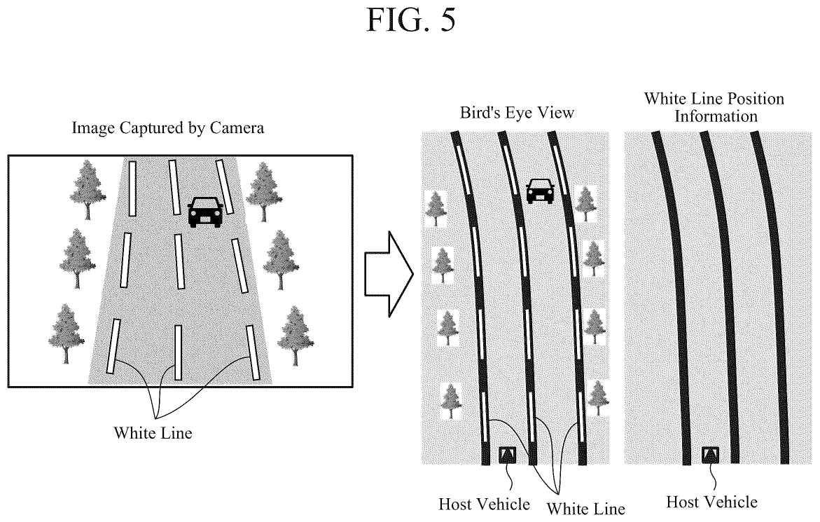

FIG. 5 is an explanatory diagram illustrating an example of detection of a white line by the first feature position detecting unit 11.

First, the first feature position detecting unit 11 extracts a white line portion from an image captured by a camera.

Next, the first feature position detecting unit 11 performs coordinate transformation on the image captured by the camera into a bird's eye view from an upper viewpoint. At this time, by performing coordinate transformation also on the extracted white line portion, the first feature position detecting unit 11 projects the white line portion on a two-dimensional plane coordinate system. The two-dimensional plane coordinate system is a coordinate system having a vehicle traveling direction and a vehicle lateral direction. The vehicle lateral direction is a vehicle width direction orthogonal to the vehicle traveling direction.

The white line on the road is generally represented by a broken line. Therefore, the first feature position detecting unit 11 calculates a curved shape of one white line by connecting a plurality of white line portions represented by a broken line.

Next, the first feature position detecting unit 11 specifies a position of the host vehicle in the vehicle lateral direction in the position of the curved white line. The first feature position detecting unit 11 calculates a distance from the position of the host vehicle to the specified position of the white line. By calculating the curved shape of one white line, the first feature position detecting unit 11 can calculate a distance from the position of the host vehicle to the position of the curved line even when there is no white line at the position of the host vehicle in the vehicle lateral direction.

The host vehicle position measuring unit 12 receives a satellite signal emitted from the satellite positioning system, and measures the position of the host vehicle using the satellite signal (step ST2 in FIG. 4).

The host vehicle position measuring unit 12 outputs host vehicle position data indicating the position of the host vehicle to each of the second feature position detecting unit 13 and the position correcting unit 16.

The satellite positioning system is not limited to a system that serves a satellite signal emitted from a GPS satellite, but may be, for example, a system that serves a satellite signal emitted from a quasi-zenith satellite.

In the host vehicle position measuring device 3 illustrated in FIG. 1, the host vehicle position measuring unit 12 measures the position of the host vehicle using a satellite signal. However, this is merely an example, and for example, the host vehicle position measuring unit 12 may acquire positioning data of an electronic reference point set by the Geospatial Information Authority of Japan and correct the position of the host vehicle using the positioning data.

In addition, the host vehicle position measuring unit 12 may measure the position of the host vehicle using a satellite signal emitted from the satellite positioning system and a sensor signal of an inertial navigation sensor. Examples of the inertial navigation sensor include an acceleration sensor and an angular velocity sensor. The host vehicle position measuring unit 12 can calculate a speed of the host vehicle and a distance from the position of the host vehicle to the position of the white line from an integral value of sensor signals of the acceleration sensor. The host vehicle position measuring unit 12 can detect the vehicle traveling direction of the host vehicle from a sensor signal of the angular velocity sensor. The host vehicle position measuring unit 12 can obtain the position of the host vehicle by calculating a moving distance from any point using the distance from the position of the host vehicle to the position of the white line and the vehicle traveling direction. In addition, the host vehicle position measuring unit 12 may acquire information indicating a vehicle speed or a vehicle steering angle from a vehicle control unit (not illustrated) and calculate a moving distance of the host vehicle.

The second feature position detecting unit 13 acquires the host vehicle position data from the host vehicle position measuring unit 12, and acquires map information from the map information storing unit 2.

The second feature position detecting unit 13 detects a relative position of a feature on the basis of the position of the host vehicle indicated by the host vehicle position data and the map information (step ST3 in FIG. 4).

The second feature position detecting unit 13 outputs the second feature position data indicating the relative position of the feature to the error calculating unit 14.

Hereinafter, feature detection processing performed by the second feature position detecting unit 13 will be specifically described.

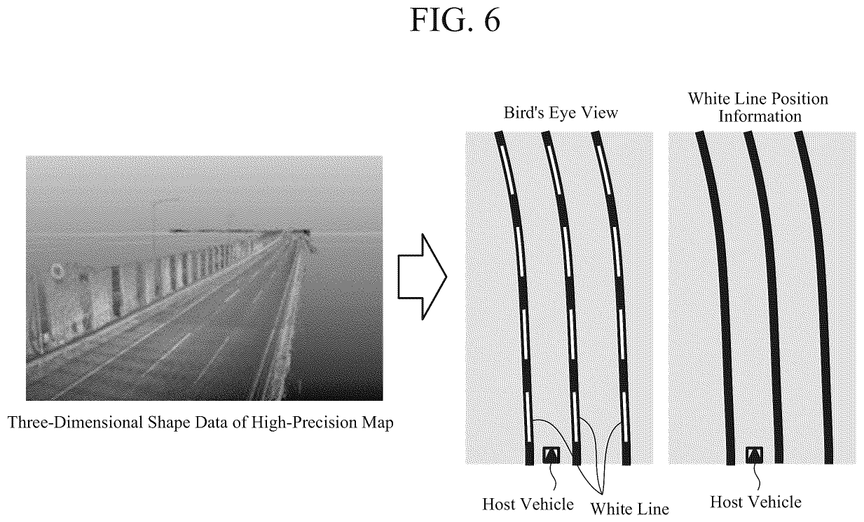

As illustrated in FIG. 6, the map information storing unit 2 stores three-dimensional shape data of a high-precision map as map information.

FIG. 6 is an explanatory diagram illustrating an example of detection of a white line by the second feature position detecting unit 13.

The second feature position detecting unit 13 extracts a white line portion from the map information.

The second feature position detecting unit 13 performs coordinate transformation on the three-dimensional shape indicated by the map information into a bird's eye view from an upper viewpoint. At this time, by performing coordinate transformation also on the extracted white line portion, the second feature position detecting unit 13 projects the white line portion on a two-dimensional plane coordinate system. The two-dimensional plane coordinate system is a coordinate system having a vehicle traveling direction and a vehicle lateral direction.

The second feature position detecting unit 13 calculates a curved shape of one white line by connecting a plurality of white line portions represented by a broken line.

Next, the second feature position detecting unit 13 specifies a position of the host vehicle in the vehicle lateral direction in the position of the curved white line. The second feature position detecting unit 13 calculates a distance from the position of the host vehicle to the specified position of the white line.

In the host vehicle position measuring device 3 illustrated in FIG. 1, the second feature position detecting unit 13 projects the white line portion on a two-dimensional plane coordinate system. However, this is merely an example, and the second feature position detecting unit 13 may calculate the distance from the position of the host vehicle to the position of the white line without converting the three-dimensional shape data indicating the white line portion into two-dimensional shape data.

The error calculating unit 14 acquires the first feature position data from the first feature position detecting unit 11, and acquires the second feature position data from the second feature position detecting unit 13.

The error calculating unit 14 calculates an error between the relative position of the feature indicated by the first feature position data and the relative position of the feature indicated by the second feature position data (step ST4 in FIG. 4).

The error calculating unit 14 outputs error data indicating the calculated error to the position correcting unit 16.

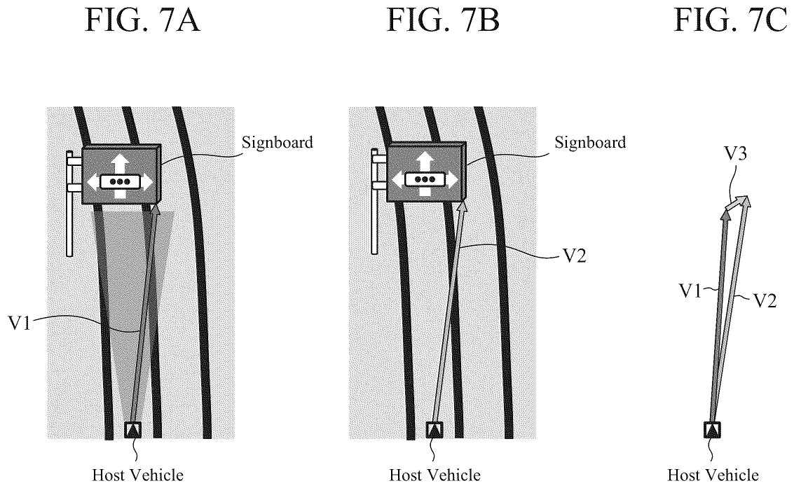

FIG. 7 is an explanatory diagram illustrating an example of error calculation by the error calculating unit 14.

FIG. 7A illustrates a relative position detected by the first feature position detecting unit 11, and FIG. 7B illustrates a relative position detected by the second feature position detecting unit 13.

In FIG. 7A, the feature is a signboard, and V1 represents a vector indicating a relative position of the signboard with respect to the host vehicle.

In FIG. 7B, the feature is a signboard, and V2 represents a vector indicating a relative position of the signboard with respect to the host vehicle.

FIG. 7C illustrates the error calculated by the error calculating unit 14.

V3 represents a vector indicating an error between the relative position of the feature indicated by the first feature position data and the relative position of the feature indicated by the second feature position data. The vector V3 is obtained, for example, by subtracting the vector V1 from the vector V2.

Here, the error calculating unit 14 calculates the error on the assumption that the feature is a signboard. However, this is merely an example, and the error calculating unit 14 may calculate the error on the assumption that the feature is, for example, a white line or a side wall. In a case where the error calculating unit 14 calculates the error on the assumption that the feature is, for example, a white line or a side wall, it may be difficult for the first feature position detecting unit 11 to detect the relative position in the vehicle traveling direction with high accuracy. For example, under a situation where there is no change in the shape of the road on which the host vehicle travels, it is difficult to detect the relative position in the vehicle traveling direction with high accuracy. Therefore, the first feature position detecting unit 11 may detect only the relative position in the vehicle lateral direction, and the error calculating unit 14 may calculate only an error in the vehicle lateral direction.

The position correcting unit 16 calculates the reliability R of position detection performed by the first feature position detecting unit 11.

Hereinafter, a calculation example of the reliability R by the position correcting unit 16 will be described.

(1) In a case where the first feature position detecting unit 11 has not been able to detect the relative position of the feature, the position correcting unit 16 determines the reliability R of position detection to be 0. When the reliability R is 0, the reliability R is a value smaller than the allowable reliability TR.

(2) When a change in the relative position detected by the first feature position detecting unit 11 within a predetermined past time is more than a threshold, the position correcting unit 16 determines the reliability R of position detection to be a value smaller than the allowable reliability TR. When the change within the predetermined past time is equal to or less than the threshold, the position correcting unit 16 determines the reliability R of position detection to be a value equal to or larger than the allowable reliability TR. The threshold may be stored in an internal memory of the position correcting unit 16 or may be supplied from the outside of the host vehicle position measuring device 3.

(3) In a case where the sensor information output from the in-vehicle sensor 1 includes reliability information, the position correcting unit 16 uses a reliability indicated by the reliability information as a reliability R of position detection.

(4) In a case where the in-vehicle sensor 1 includes a plurality of types of sensor devices and pieces of sensor information indicated by the plurality of sensor devices are significantly different from each other, the position correcting unit 16 determines the reliability R of position detection to be 0.

The position correcting unit 16 compares the reliability R of position detection performed by the first feature position detecting unit 11 with the allowable reliability TR.

If the reliability R of position detection is equal to or larger than the allowable reliability TR (step ST5 in FIG. 4: NO), the position correcting unit 16 supplies learning data to the learning model 15a. The learning data includes the host vehicle position data indicating the position of the host vehicle measured by the host vehicle position measuring unit 12 and the error data indicating the error calculated by the error calculating unit 14.

The position correcting unit 16 causes the learning model 15a to learn a measuring error using the error indicated by the error data included in the learning data as the measuring error (step ST7 in FIG. 4).

In the host vehicle position measuring device 3 illustrated in FIG. 1, the position correcting unit 16 causes the learning model 15a to learn the measuring error. However, this is merely an example, and an external server of the host vehicle position measuring device 3 may have a learning processing function of the position correcting unit 16, and the external server may cause the learning model 15a to learn the measuring error.

The host vehicle position measuring device 3 illustrated in FIG. 1 includes the learning model storing unit 15. However, this is merely an example, and the learning model storing unit 15 may be disposed outside the host vehicle position measuring device 3 or may be included on an external server.

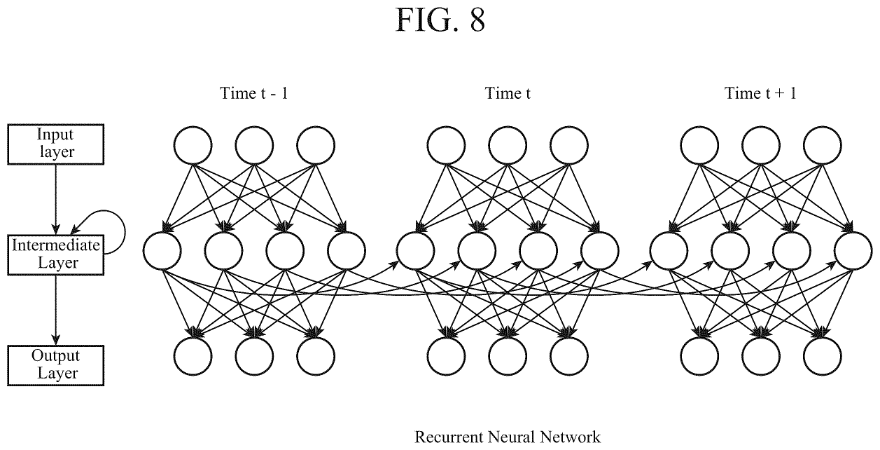

FIG. 8 is an explanatory diagram illustrating a recurrent neural network that implements the learning model 15a.

For example, the recurrent neural network recurrently calculates an output result of a neural network by using an output result of an intermediate layer of the neural network calculated at a time t as an input value of the intermediate layer of the neural network at a time t+1. As a result, the output result of the intermediate layer calculated at the time t is taken over to the neural network at the time t+1, and therefore learning based on time-series data is possible.

Here, the learning data includes the host vehicle position data indicating the position of the host vehicle measured by the host vehicle position measuring unit 12 and the error data indicating the error calculated by the error calculating unit 14. However, this is merely an example, and the position correcting unit 16 may acquire vehicle speed information indicating a speed of the host vehicle or steering angle information indicating a steering angle of the host vehicle from a vehicle control unit (not illustrated), and may add the vehicle speed information or the steering angle information to the learning data. In addition, the position correcting unit 16 may add relative position information indicating a relative position between the position of the host vehicle measured by the host vehicle position measuring unit 12 and the position of a satellite in the satellite positioning system to the learning data.

In these cases, the learning model 15a learns measuring errors corresponding to the host vehicle position data and the vehicle speed information, the steering angle information, or the relative position information.

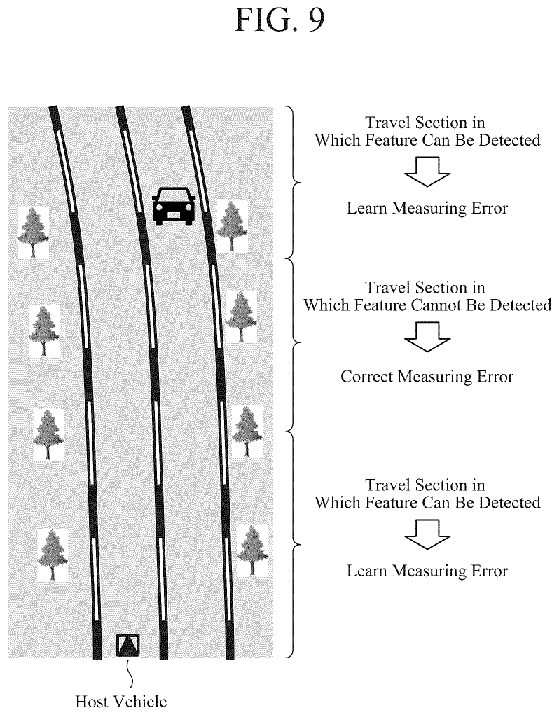

FIG. 9 is an explanatory diagram illustrating a travel section in which the first feature position detecting unit 11 can detect a relative position of a feature and a travel section in which the first feature position detecting unit 11 cannot detect the relative position of the feature.

The travel section in which the relative position of the feature can be detected is a travel section in which the reliability R of position detection is equal to or larger than the allowable reliability TR.

The travel section in which the relative position of the feature cannot be detected is not limited to a travel section in which the first feature position detecting unit 11 cannot detect the relative position of the feature at all, but includes a travel section in which the reliability R of position detection is smaller than the allowable reliability TR.

If the reliability R of position detection is smaller than the allowable reliability TR (step ST5 in FIG. 4: YES), the position correcting unit 16 supplies the host vehicle position data indicating the position of the host vehicle measured by the host vehicle position measuring unit 12 to the learning model 15a, and acquires measuring error data indicating a measuring error corresponding to the position indicated by the host vehicle position data from the learning model 15a.

When the vehicle speed information, the steering angle information, or the relative position information is included in the learning data, the position correcting unit 16 acquires the vehicle speed information, the steering angle information, or the relative position information, and supplies the vehicle speed information, the steering angle information, or the relative position information to the learning model 15a together with the host vehicle position data. Then, the position correcting unit 16 acquires measuring error data indicating measuring errors corresponding to the host vehicle position data and the vehicle speed information, the steering angle information, or the relative position information from the learning model 15a.

The section in which the reliability R of position detection is smaller than the allowable reliability TR is a travel section in which the relative position of the feature can be detected (see FIG. 9).

The position correcting unit 16 corrects the position of the host vehicle measured by the host vehicle position measuring unit 12 using the measuring error indicated by the measuring error data (step ST6 in FIG. 4).

Hereinafter, the correction processing of the host vehicle position performed by the position correcting unit 16 will be specifically described.

The position correcting unit 16 sets a three-dimensional position of the host vehicle as (x₁, y₁, z₁) on the basis of the host vehicle position data output from the host vehicle position measuring unit 12.

In addition, the position correcting unit 16 sets a three-dimensional position of the measuring error as (xₑ, yₑ, zₑ) on the basis of the measuring error data output from the learning model 15a.

The position correcting unit 16 calculates a corrected three-dimensional position (x₁−xₑ, y₁−yₑ, z₁−zₑ) of the host vehicle by subtracting the three-dimensional position (xₑ, yₑ, zₑ) of the measuring error from the three-dimensional position (x₁, y₁, z₁) of the host vehicle.

Here, the position correcting unit 16 expresses the position of the host vehicle by the three-dimensional position (x₁, y₁, z₁). However, this is merely an example, and the position correcting unit 16 may convert the three-dimensional position (x₁, y₁, z₁) into a two-dimensional position (x₁, y₁) of a two-dimensional coordinate system and calculate a corrected two-dimensional position (x₁−xₑ, y₁−yₑ) of the host vehicle. The two-dimensional coordinate system is a coordinate system having a vehicle traveling direction and a vehicle lateral direction.

In addition, in a case where the feature is a white line or a side wall, only a relative position in the vehicle lateral direction can be detected with high accuracy, and therefore, the position correcting unit 16 may convert the three-dimensional position (x₁, y₁, z₁) into a one-dimensional position (x₁) in the vehicle lateral direction and calculate a corrected one-dimensional position (x₁−xₑ) of the host vehicle.

If the reliability R of position detection performed by the first feature position detecting unit 11 is equal to or larger than the allowable reliability TR (step ST5 in FIG. 4: NO), the position correcting unit 16 outputs, as a position measuring result, the host vehicle position data indicating the position of the host vehicle measured by the host vehicle position measuring unit 12 to, for example, an automatic driving system (step ST8 in FIG. 4).

If the reliability R of position detection performed by the first feature position detecting unit 11 is smaller than the allowable reliability TR (step ST5 in FIG. 4: YES), the position correcting unit 16 outputs, as a position measuring result, the corrected position data indicating the corrected position to, for example, the automatic driving system (step ST8 in FIG. 4).

The automatic driving system controls the host vehicle, for example, in such a manner that the host vehicle travels in a road lane on the basis of the position of the host vehicle measured by the host vehicle position measuring device 3.

In the above first embodiment, the host vehicle position measuring device 3 is configured to include: the host vehicle position measuring unit 12 that measures a position of a host vehicle using a satellite signal emitted from a satellite positioning system; and the position correcting unit 16 that estimates, using an error estimating model for estimating a position measuring error in the host vehicle position measuring unit 12, a measuring error corresponding to the position of the host vehicle measured by the host vehicle position measuring unit 12, and corrects the position of the host vehicle measured by the host vehicle position measuring unit 12 using the measuring error. Therefore, the host vehicle position measuring device 3 can improve host vehicle position measuring accuracy even in a situation where a position of a feature present around the host vehicle cannot be detected, on the basis of sensor information from the in-vehicle sensor 1.

In addition, in the first embodiment, the host vehicle position measuring device 3 is configured to include: the first feature position detecting unit 11 that acquires sensor information from the in-vehicle sensor 1 that observes surroundings of the host vehicle and detects a relative position of a feature present around the host vehicle with respect to the host vehicle on the basis of the sensor information; the second feature position detecting unit 13 that detects a relative position of the feature with respect to the host vehicle on the basis of the position of the host vehicle measured by the host vehicle position measuring unit 12 and map information; and the error calculating unit 14 that calculates an error between the relative position detected by the first feature position detecting unit 11 and the relative position detected by the second feature position detecting unit 13. In addition, in the host vehicle position measuring device 3, the position correcting unit 16 calculates a reliability of position detection performed by the first feature position detecting unit 11, and when the reliability is equal to or larger than an allowable reliability, the position correcting unit 16 supplies, as learning data, position data indicating the position of the vehicle measured by the host vehicle position measuring unit 12 and error data indicating the error calculated by the error calculating unit 14 to the learning model 15a, and causes the learning model 15a to learn a measuring error by using the error indicated by the error data as the measuring error. In addition, when the calculated reliability is smaller than the allowable reliability, the position correcting unit 16 supplies the position data indicating the position of the host vehicle measured by the host vehicle position measuring unit 12 to the learning model 15a, acquires measuring error data indicating a measuring error corresponding to the position indicated by the position data from the learning model 15a, and corrects the position of the host vehicle measured by the host vehicle position measuring unit 12 using the measuring error. Therefore, when the reliability of position detection performed by the first feature position detecting unit 11 is smaller than the allowable reliability, the host vehicle position measuring device 3 can increase host vehicle position measuring accuracy. Meanwhile, when the reliability of position detection performed by the first feature position detecting unit 11 is equal to or larger than the allowable reliability, the host vehicle position measuring device 3 can increase learning accuracy of the measuring error by causing the learning model 15a to learn the measuring error.

### Second Embodiment

In a second embodiment, a host vehicle position measuring device 3 including a position correcting unit 18 that estimates a position measuring error in a host vehicle position measuring unit 12 using a state space model as an error estimating model will be described.

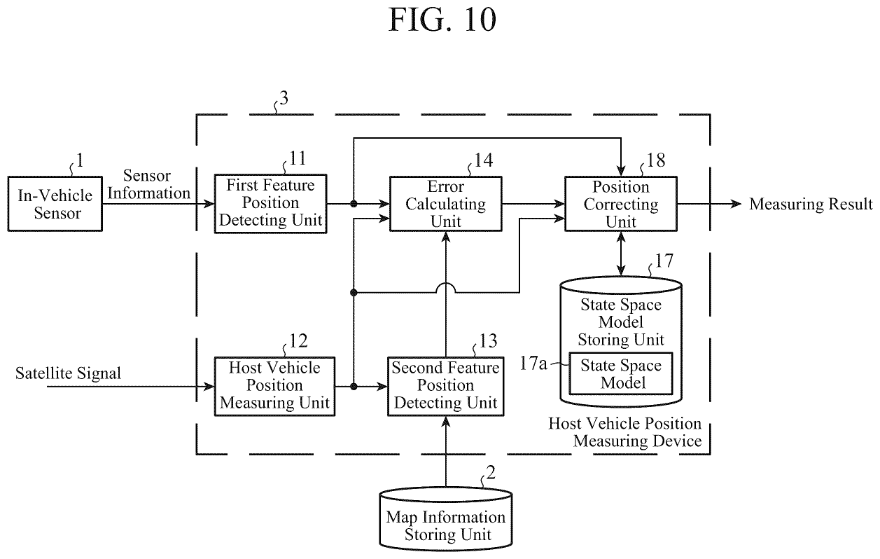

FIG. 10 is a configuration diagram illustrating the host vehicle position measuring device 3 according to the second embodiment. In FIG. 10, the same reference numerals as in FIG. 1 indicate the same or corresponding parts, and therefore description thereof is omitted.

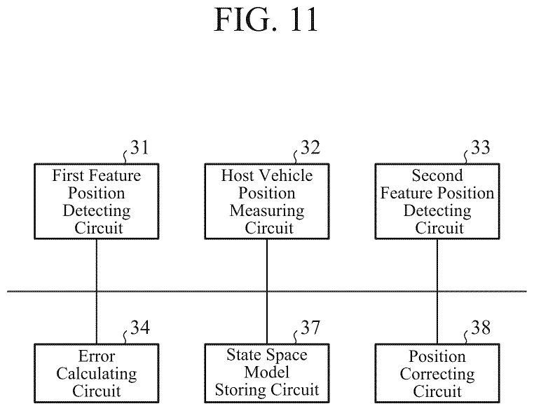

FIG. 11 is a hardware configuration diagram illustrating hardware of the host vehicle position measuring device 3 according to the second embodiment. In FIG. 11, the same reference numerals as in FIG. 2 indicate the same or corresponding parts, and therefore description thereof is omitted.

The host vehicle position measuring device 3 illustrated in FIG. 10 includes a first feature position detecting unit 11, the host vehicle position measuring unit 12, a second feature position detecting unit 13, an error calculating unit 14, a state space model storing unit 17, and the position correcting unit 18.

The state space model storing unit 17 is implemented by, for example, a state space model storing circuit 37 illustrated in FIG. 11.

The state space model storing unit 17 stores a state space model 17a as an error estimating model.

The state space model 17a is implemented by, for example, a Kalman filter, a particle filter, or an α-β filter.

The state space model 17a indicates a state equation of a position measuring error in the host vehicle position measuring unit 12.

The position correcting unit 18 is implemented by, for example, a position correcting circuit 38 illustrated in FIG. 11.

The position correcting unit 18 calculates a measuring error by putting the position of the host vehicle measured by the host vehicle position measuring unit 12 into the state equation indicated by the state space model 17a.

The position correcting unit 18 corrects the position of the host vehicle measured by the host vehicle position measuring unit 12 using the measuring error.

The position correcting unit 18 outputs, as a position measuring result, corrected position data indicating the corrected position to, for example, an automatic driving system.

In the host vehicle position measuring device 3 illustrated in FIG. 10, the position correcting unit 18 calculates a measuring error by putting the position of the host vehicle measured by the host vehicle position measuring unit 12 into the state equation. However, this is merely an example, and the position correcting unit 18 may calculate the measuring error by putting a relative position detected by the first feature position detecting unit 11 into the state equation. In addition, the position correcting unit 18 may calculate the measuring error by putting the position of the host vehicle measured by the host vehicle position measuring unit 12 and the relative position detected by the first feature position detecting unit 11 into the state equation. In addition, the position correcting unit 18 may calculate the measuring error by putting an error calculated by the error calculating unit 14 into the state equation.

In FIG. 10, it is assumed that each of the first feature position detecting unit 11, the host vehicle position measuring unit 12, the second feature position detecting unit 13, the error calculating unit 14, the state space model storing unit 17, and the position correcting unit 18, which are constituent elements of the host vehicle position measuring device 3, is implemented by dedicated hardware as illustrated in FIG. 11. That is, it is assumed that the host vehicle position measuring device 3 is implemented by the first feature position detecting circuit 31, the host vehicle position measuring circuit 32, the second feature position detecting circuit 33, the error calculating circuit 34, the state space model storing circuit 37, and the position correcting circuit 38.

Here, to the state space model storing circuit 37, for example, a nonvolatile or volatile semiconductor memory such as RAM, ROM, flash memory, EPROM, or EEPROM, a magnetic disk, a flexible disk, an optical disk, a compact disk, a mini disk, or DVD corresponds.

To each of the first feature position detecting circuit 31, the host vehicle position measuring circuit 32, the second feature position detecting circuit 33, the error calculating circuit 34, and the position correcting circuit 38, a single circuit, a composite circuit, a programmed processor, a parallel programmed processor, ASIC, FPGA, or a combination thereof corresponds.

The constituent elements of the host vehicle position measuring device 3 are not limited to those implemented by dedicated hardware, and the host vehicle position measuring device 3 may be implemented by software, firmware, or a combination of software and firmware.

In a case where the host vehicle position measuring device 3 is implemented by software, firmware, or the like, the state space model storing unit 17 is constituted on the memory 51 illustrated in FIG. 3. A program for causing a computer to execute a processing procedure performed in each of the first feature position detecting unit 11, the host vehicle position measuring unit 12, the second feature position detecting unit 13, the error calculating unit 14, and the position correcting unit 18 is stored in the memory 51. Then, the processor 52 illustrated in FIG. 3 executes the program stored in the memory 51.

FIG. 11 illustrates an example in which each of the constituent elements of the host vehicle position measuring device 3 is implemented by dedicated hardware, and FIG. 3 illustrates an example in which the host vehicle position measuring device 3 is implemented by software, firmware, or the like. However, this is only an example, and some constituent elements in the host vehicle position measuring device 3 may be implemented by dedicated hardware, and the remaining constituent elements may be implemented by software, firmware, or the like.

Next, an operation of the host vehicle position measuring device 3 illustrated in FIG. 10 will be described. Since the units other than the state space model storing unit 17 and the position correcting unit 18 are similar to those of the host vehicle position measuring device 3 illustrated in FIG. 1, an operation of the position correcting unit 18 will be mainly described here.

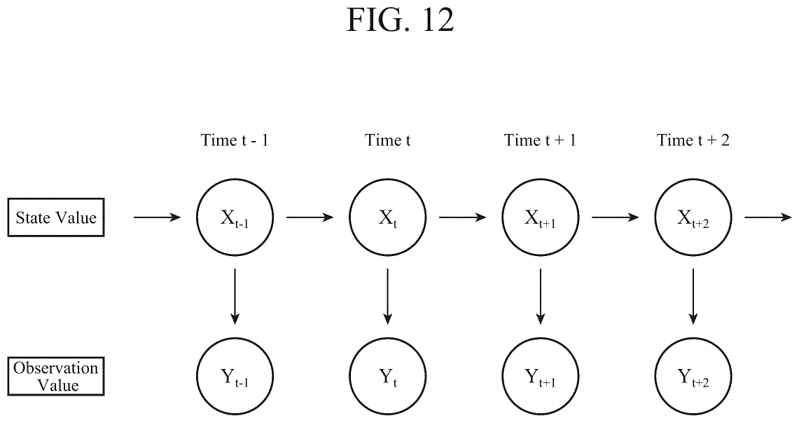

FIG. 12 is an explanatory diagram illustrating an example of the state space model 17a.

In FIG. 12, a state value indicates a state of a measuring error X. For example, Xₖ₋₁ indicates a position measuring error at a time tₖ₋₁ in the host vehicle position measuring unit 12, and Xₖ indicates a position measuring error at a time tₖ in the host vehicle position measuring unit 12.

An observation value Y indicates the position of the host vehicle measured by the host vehicle position measuring unit 12. Yₖ₋₁ indicates the position of the host vehicle at the time tₖ₋₁ measured by the host vehicle position measuring unit 12 at the time Tₖ₋₁, and Yₖ indicates the position of the host vehicle at the time tₖ₋₁ measured by the host vehicle position measuring unit 12.

If observation noise is ON, the observation value Y is obtained by adding the observation noise ON to the measuring error X. Therefore, an observation equation is expressed as the following formula (1).

Xₖ=Yₖ−ON (1)

In addition, the state equation indicating a temporal change of the measuring error X is expressed as the following formula (2) on the assumption that the measuring error X fluctuates at a constant speed.

Xₖ=Xₖ₋₁(dXₖ₋₁/dt)·(tₖ−tₖ₋₁)+PN (2)

In formula (2), PN represents predicted noise. (dXₖ₋₁/dt) is a time differential value of the measuring error Xₖ₋₁.

In a case where a state value at any time is calculated from the observation equation and the state equation, when the state space model 17a is achieved using a Kalman filter, the measuring error Xₖ is expressed as the following formula (3).

Xₖ=Xₖ₋₁+Gₖ·(Yₖ−(Xₖ₋₁+dXₖ₋₁/dt)·(tₖ−tₖ₋₁)) (3)

In formula (3), Gₖ represents a Kalman gain at the time tₖ.

The position correcting unit 18 calculates a measuring error Xₖ at the time tₖ by putting the position Yₖ of the host vehicle at the time tₖ into formula (3) as the position of the host vehicle measured by the host vehicle position measuring unit 12.

The position correcting unit 18 corrects the position of the host vehicle measured by the host vehicle position measuring unit 12 using the measuring error Xₖ. Since the position correcting processing is similar to the position correcting processing performed by the position correcting unit 16 illustrated in FIG. 1, detailed description thereof is omitted.

The position correcting unit 18 outputs, as a position measuring result, corrected position data indicating the corrected position to, for example, an automatic driving system.

In the above second embodiment, the error estimating model is a state space model indicating a state equation of a position measuring error in the host vehicle position measuring unit 12. The host vehicle position measuring device 3 illustrated in FIG. 10 is configured in such a manner that the position correcting unit calculates a measuring error by putting the position of the host vehicle measured by the host vehicle position measuring unit 12 into the state equation, and corrects the position of the host vehicle measured by the host vehicle position measuring unit 12 using the measuring error. Therefore, similarly to the host vehicle position measuring device 3 illustrated in FIG. 1, the host vehicle position measuring device 3 illustrated in FIG. 10 can improve host vehicle position measuring accuracy even in a situation where a position of a feature present around the host vehicle cannot be detected, on the basis of sensor information from the in-vehicle sensor 1. In addition, the host vehicle position measuring device 3 illustrated in FIG. 10 can calculate a measuring error without learning a large amount of learning data in advance like the learning model 15a illustrated in FIG. 1.

### Third Embodiment

In a third embodiment, a host vehicle position measuring device 3 including a position correcting unit 19 that calculates a measuring error by putting a time at which an error is calculated by an error calculating unit 14 into an approximate function will be described.

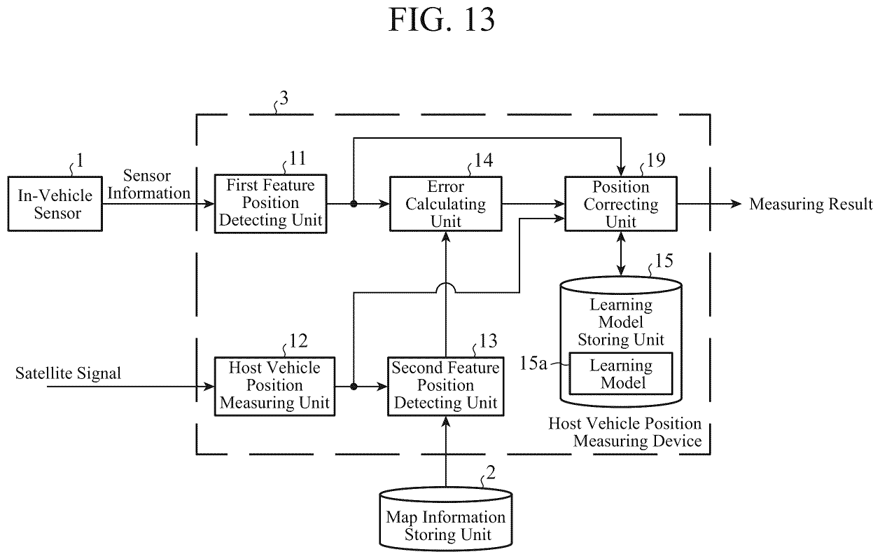

FIG. 13 is a configuration diagram illustrating the host vehicle position measuring device 3 according to the third embodiment. In FIG. 13, the same reference numerals as in FIG. 1 indicate the same or corresponding parts, and therefore description thereof is omitted.

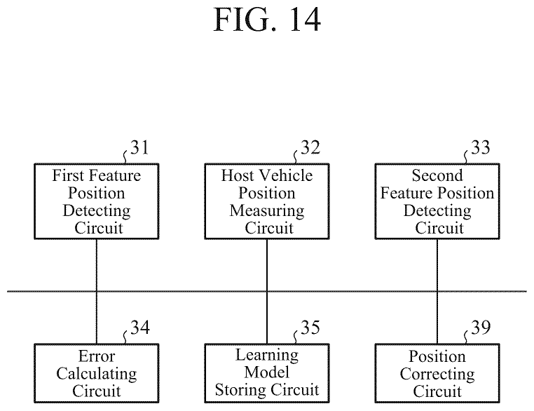

FIG. 14 is a hardware configuration diagram illustrating hardware of the host vehicle position measuring device 3 according to the third embodiment. In FIG. 14, the same reference numerals as in FIG. 2 indicate the same or corresponding parts, and therefore description thereof is omitted.

The host vehicle position measuring device 3 illustrated in FIG. 13 includes a first feature position detecting unit 11, a host vehicle position measuring unit 12, a second feature position detecting unit 13, the error calculating unit 14, a learning model storing unit 15, and the position correcting unit 19.

The position correcting unit 19 is implemented by, for example, a position correcting circuit 39 illustrated in FIG. 14.

Position correcting processing performed by the position correcting unit 19 is similar to the position correcting processing performed by the position correcting unit 16 illustrated in FIG. 1.

Similarly to the position correcting unit 16 illustrated in FIG. 1, the position correcting unit 19 calculates the reliability R of position detection performed by the first feature position detecting unit 11.

When the reliability R of position detection performed by the first feature position detecting unit 11 is equal to or larger than the allowable reliability TR, the position correcting unit 19 calculates a position measuring error in the host vehicle position measuring unit 12 by putting a time at which an error is calculated by the error calculating unit 14 into an approximate function indicating a measuring error corresponding to a time.

The position correcting unit 19 supplies learning data including host vehicle position data indicating the position of the host vehicle measured by the host vehicle position measuring unit 12 and error data indicating the calculated measuring error to a learning model 15a.

The position correcting unit 19 causes the learning model 15a to learn the measuring error indicated by the error data included in the learning data.

In FIG. 13, it is assumed that each of the first feature position detecting unit 11, the host vehicle position measuring unit 12, the second feature position detecting unit 13, the error calculating unit 14, the learning model storing unit 15, and the position correcting unit 19, which are constituent elements of the host vehicle position measuring device 3, is implemented by dedicated hardware as illustrated in FIG. 14. That is, it is assumed that the host vehicle position measuring device 3 is implemented by the first feature position detecting circuit 31, the host vehicle position measuring circuit 32, the second feature position detecting circuit 33, the error calculating circuit 34, the learning model storing circuit 35, and the position correcting circuit 39.

To each of the first feature position detecting circuit 31, the host vehicle position measuring circuit 32, the second feature position detecting circuit 33, the error calculating circuit 34, and the position correcting circuit 39, a single circuit, a composite circuit, a programmed processor, a parallel programmed processor, ASIC, FPGA, or a combination thereof corresponds.

The constituent elements of the host vehicle position measuring device 3 are not limited to those implemented by dedicated hardware, and the host vehicle position measuring device 3 may be implemented by software, firmware, or a combination of software and firmware.

In a case where the host vehicle position measuring device 3 is implemented by software, firmware, or the like, the learning model storing unit 15 is constituted on the memory 51 illustrated in FIG. 3. A program for causing a computer to execute a processing procedure performed in each of the first feature position detecting unit 11, the host vehicle position measuring unit 12, the second feature position detecting unit 13, the error calculating unit 14, and the position correcting unit 19 is stored in the memory 51. Then, the processor 52 illustrated in FIG. 3 executes the program stored in the memory 51.

FIG. 14 illustrates an example in which each of the constituent elements of the host vehicle position measuring device 3 is implemented by dedicated hardware, and FIG. 3 illustrates an example in which the host vehicle position measuring device 3 is implemented by software, firmware, or the like. However, this is only an example, and some constituent elements in the host vehicle position measuring device 3 may be implemented by dedicated hardware, and the remaining constituent elements may be implemented by software, firmware, or the like.

Next, an operation of the host vehicle position measuring device 3 illustrated in FIG. 13 will be described. Since the units other than the position correcting unit 19 are similar to those of the host vehicle position measuring device 3 illustrated in FIG. 1, only an operation of the position correcting unit 19 will be described here.

An internal memory of the position correcting unit 19 stores an approximate formula of an approximate function as expressed in the following formula (4).

Y=αt³+βt²+γt+δ (4)

In formula (4), Y represents a measuring error corresponding to a time t. Each of α, β, γ, and δ represents a coefficient of a polynomial indicating an approximation function.

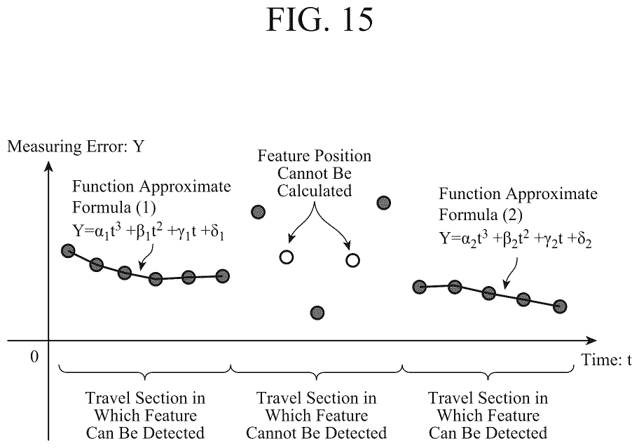

FIG. 15 is an explanatory diagram illustrating an example of an approximate function indicating a measuring error Y corresponding to a time t.

In FIG. 15, the horizontal axis represents a time t, and the vertical axis represents the measuring error Y.

FIG. 15 illustrates the following two approximate formulas as approximate formulas of an approximate function.

Y=α₁t³+β₁t²+y₁t+δ₁ (4′)

Y=α₂t³+β₂t²+γ₂t+δ₂ (4″)

The position correcting unit 19 calculates the coefficients α, β, γ, and δ of the polynomial in advance.

Specifically, by putting each of errors Y at a plurality of times t calculated by the error calculating unit 14 into the polynomial expressed in formula (4), the position correcting unit 19 generates a plurality of equations having the different errors Y. Then, the position correcting unit 19 calculates the coefficients α, β, γ, and δ of the polynomial by solving the plurality of equations as simultaneous equations.

When the travel section is a travel section in which the first feature position detecting unit 11 can detect a relative position of a feature, the position correcting unit 19 calculates the measuring error Y by putting a time t at which the error is calculated by the error calculating unit 14 into formula (4). As described above, the travel section in which the relative position of the feature can be detected is a travel section in which the reliability R of position detection performed by the first feature position detecting unit 11 is equal to or larger than the allowable reliability TR.

By supplying the learning data including the host vehicle position data indicating the position of the host vehicle measured by the host vehicle position measuring unit 12 and the error data indicating the measuring error Y to the learning model 15a, the position correcting unit 19 causes the learning model 15a to learn the measuring error indicated by the error data included in the learning data.

In the above third embodiment, the host vehicle position measuring device 3 illustrated in FIG. 13 is configured in such a manner that the position correcting unit 19 calculates a position measuring error in the host vehicle position measuring unit 12 by putting a time at which an error is calculated by the error calculating unit 14 into an approximate function indicating a measuring error corresponding to a time, supplies the learning data including the position data indicating the position of the host vehicle measured by the host vehicle position measuring unit 12 and the error data indicating the calculated measuring error to the learning model 15a, and causes the learning model 15a to learn the measuring error. Therefore, similarly to the host vehicle position measuring device 3 illustrated in FIG. 1, the host vehicle position measuring device 3 illustrated in FIG. 13 can improve host vehicle position measuring accuracy even in a situation where a position of a feature present around the host vehicle cannot be detected, on the basis of sensor information from the in-vehicle sensor 1. In addition, similarly to the host vehicle position measuring device 3 illustrated in FIG. 1, the host vehicle position measuring device 3 illustrated in FIG. 13 can cause the learning model 15a to learn the measuring error.

### Fourth Embodiment

In a fourth embodiment, a host vehicle position measuring device 3 including a position correcting unit 20 that calculates, as a position measuring error in a host vehicle position measuring unit 12, an average value of errors at a plurality of times calculated by an error calculating unit 14 will be described.

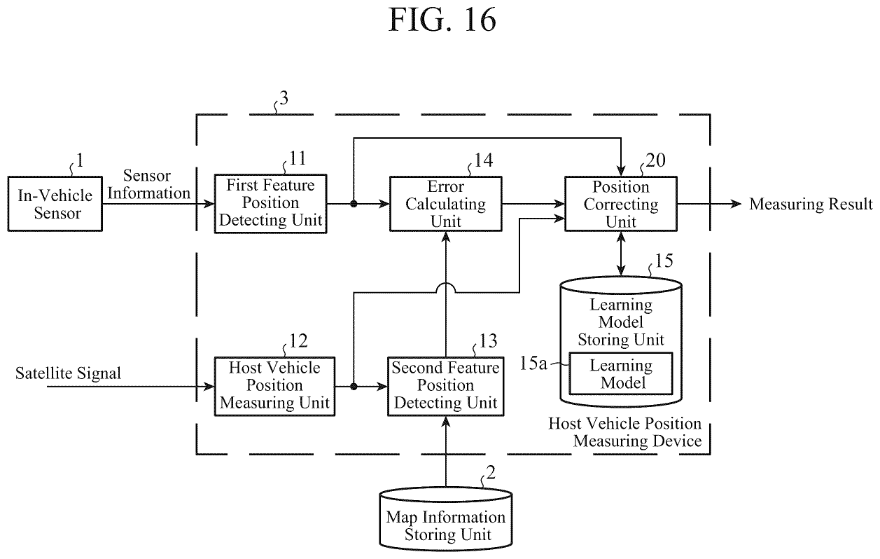

FIG. 16 is a configuration diagram illustrating the host vehicle position measuring device 3 according to the fourth embodiment. In FIG. 16, the same reference numerals as in FIG. 1 indicate the same or corresponding parts, and therefore description thereof is omitted.

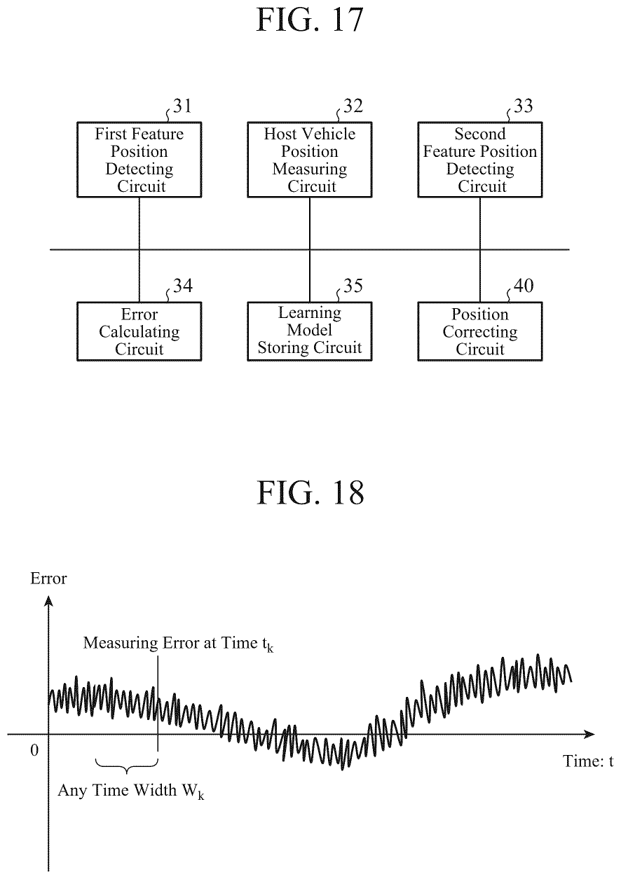

FIG. 17 is a hardware configuration diagram illustrating hardware of the host vehicle position measuring device 3 according to the fourth embodiment. In FIG. 17, the same reference numerals as in FIG. 2 indicate the same or corresponding parts, and therefore description thereof is omitted.

The host vehicle position measuring device 3 illustrated in FIG. 16 includes a first feature position detecting unit 11, the host vehicle position measuring unit 12, a second feature position detecting unit 13, the error calculating unit 14, a learning model storing unit 15, and the position correcting unit 20.

The position correcting unit 20 is implemented by, for example, a position correcting circuit 40 illustrated in FIG. 17.

Position correcting processing performed by the position correcting unit 20 is similar to the position correcting processing performed by the position correcting unit 16 illustrated in FIG. 1.

Similarly to the position correcting unit 16 illustrated in FIG. 1, the position correcting unit 20 calculates the reliability R of position detection performed by the first feature position detecting unit 11.

When the reliability R of position detection performed by the first feature position detecting unit 11 is equal to or larger than the allowable reliability TR, the position correcting unit 20 calculates, as a position measuring error in the host vehicle position measuring unit 12, an average value of errors at a plurality of times calculated by the error calculating unit 14.

The position correcting unit 20 supplies learning data including host vehicle position data indicating the position of the host vehicle measured by the host vehicle position measuring unit 12 and the calculated average value to a learning model 15a.

The position correcting unit 20 causes the learning model 15a to learn the average value included in the learning data.

In FIG. 16, it is assumed that each of the first feature position detecting unit 11, the host vehicle position measuring unit 12, the second feature position detecting unit 13, the error calculating unit 14, the learning model storing unit 15, and the position correcting unit 20, which are constituent elements of the host vehicle position measuring device 3, is implemented by dedicated hardware as illustrated in FIG. 17. That is, it is assumed that the host vehicle position measuring device 3 is implemented by the first feature position detecting circuit 31, the host vehicle position measuring circuit 32, the second feature position detecting circuit 33, the error calculating circuit 34, the learning model storing circuit 35, and the position correcting circuit 20.

To each of the first feature position detecting circuit 31, the host vehicle position measuring circuit 32, the second feature position detecting circuit 33, the error calculating circuit 34, and the position correcting circuit 20, a single circuit, a composite circuit, a programmed processor, a parallel programmed processor, ASIC, FPGA, or a combination thereof corresponds.

The constituent elements of the host vehicle position measuring device 3 are not limited to those implemented by dedicated hardware, and the host vehicle position measuring device 3 may be implemented by software, firmware, or a combination of software and firmware.

In a case where the host vehicle position measuring device 3 is implemented by software, firmware, or the like, the learning model storing unit 15 is constituted on the memory 51 illustrated in FIG. 3. A program for causing a computer to execute a processing procedure performed in each of the first feature position detecting unit 11, the host vehicle position measuring unit 12, the second feature position detecting unit 13, the error calculating unit 14, and the position correcting unit 40 is stored in the memory 51. Then, the processor 52 illustrated in FIG. 3 executes the program stored in the memory 51.

FIG. 17 illustrates an example in which each of the constituent elements of the host vehicle position measuring device 3 is implemented by dedicated hardware, and FIG. 3 illustrates an example in which the host vehicle position measuring device 3 is implemented by software, firmware, or the like. However, this is only an example, and some constituent elements in the host vehicle position measuring device 3 may be implemented by dedicated hardware, and the remaining constituent elements may be implemented by software, firmware, or the like.

Next, an operation of the host vehicle position measuring device 3 illustrated in FIG. 16 will be described. Since the units other than the position correcting unit 20 are similar to those of the host vehicle position measuring device 3 illustrated in FIG. 1, only an operation of the position correcting unit 20 will be described here.

FIG. 18 is an explanatory diagram illustrating an example of a measuring error calculated by the position correcting unit 20.

In FIG. 18, the horizontal axis represents a time, and the vertical axis represents an error calculated by the error calculating unit 14.

Similarly to the position correcting unit 16 illustrated in FIG. 1, the position correcting unit 20 calculates the reliability R of position detection performed by the first feature position detecting unit 11.

When the reliability R of position detection performed by the first feature position detecting unit 11 is equal to or larger than the allowable reliability TR, the position correcting unit 20 calculates, as a position measuring error in the host vehicle position measuring unit 12, an average value of errors at a plurality of times calculated by the error calculating unit 14.

For example, in a case where the position correcting unit 20 calculates a measuring error at a time tₖ, as illustrated in FIG. 18, the position correcting unit 20 calculates an average value of a plurality of measuring errors included in a time width Wₖ between a certain time before the time tₖ and the time tₖ.

The position correcting unit 20 supplies learning data including host vehicle position data indicating the position of the host vehicle measured by the host vehicle position measuring unit 12 and the calculated average value to a learning model 15a.

The position correcting unit 20 causes the learning model 15a to learn the average value included in the learning data.

In the above fourth embodiment, the host vehicle position measuring device 3 illustrated in FIG. 16 is configured in such a manner that the position correcting unit 20 calculates, as a position measuring error in the host vehicle position measuring unit 12, an average value of errors at a plurality of times calculated by the error calculating unit 14, supplies the learning data including the position data indicating the position of the host vehicle measured by the host vehicle position measuring unit 12 and the average value to the learning model 15a, and causes the learning model 15a to learn the average value. Therefore, similarly to the host vehicle position measuring device 3 illustrated in FIG. 1, the host vehicle position measuring device 3 illustrated in FIG. 16 can improve host vehicle position measuring accuracy even in a situation where a position of a feature present around the host vehicle cannot be detected, on the basis of sensor information from the in-vehicle sensor 1. In addition, the host vehicle position measuring device 3 illustrated in FIG. 16 can suppress vibration of a measuring error included in the learning data in a minute time and can cause the learning model 15a to learn the measuring error more stably than the host vehicle position measuring device 3 illustrated in FIG. 1.

### Fifth Embodiment

In a fifth embodiment, description will be given of a host vehicle position measuring device 3 including a position correcting unit 21 that lowers a learning weight for the position of the host vehicle measured by a host vehicle position measuring unit 12 before a change in the position becomes equal to or larger than a threshold at the time of causing a learning model 15a to learn a measuring error when the change in the position of the host vehicle measured by the host vehicle position measuring unit 12 is equal to or larger than the threshold.

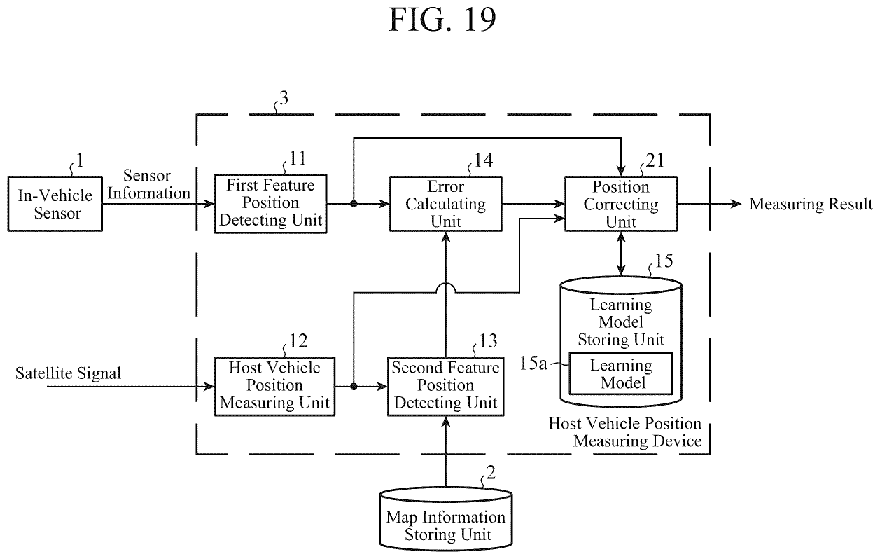

FIG. 19 is a configuration diagram illustrating the host vehicle position measuring device 3 according to the fifth embodiment. In FIG. 19, the same reference numerals as in FIG. 1 indicate the same or corresponding parts, and therefore description thereof is omitted.

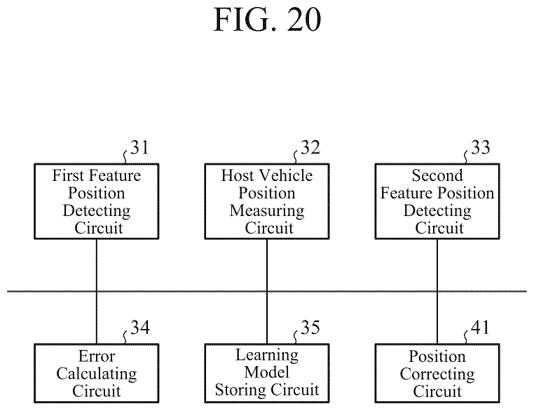

FIG. 20 is a hardware configuration diagram illustrating hardware of the host vehicle position measuring device 3 according to the fifth embodiment. In FIG. 20, the same reference numerals as in FIG. 2 indicate the same or corresponding parts, and therefore description thereof is omitted.

The host vehicle position measuring device 3 illustrated in FIG. 19 includes a first feature position detecting unit 11, the host vehicle position measuring unit 12, a second feature position detecting unit 13, an error calculating unit 14, a learning model storing unit 15, and the position correcting unit 21.

The position correcting unit 21 is implemented by, for example, a position correcting circuit 41 illustrated in FIG. 20.

Position correcting processing performed by the position correcting unit 21 is similar to the position correcting processing performed by the position correcting unit 16 illustrated in FIG. 1.

Similarly to the position correcting unit 16 illustrated in FIG. 1, the position correcting unit 21 calculates the reliability R of position detection performed by the first feature position detecting unit 11.

Similarly to the position correcting unit 16 illustrated in FIG. 1, the position correcting unit 21 supplies learning data including host vehicle position data indicating the position of the host vehicle measured by the host vehicle position measuring unit 12 and error data indicating an error calculated by the error calculating unit 14 to the learning model 15a.

Similarly to the position correcting unit 16 illustrated in FIG. 1, the position correcting unit 21 causes the learning model 15a to learn a measuring error using the error indicated by the error data included in the learning data as the measuring error.

When a change in the position of the host vehicle measured by the host vehicle position measuring unit 12 is equal to or larger than the threshold, at the time of causing the learning model 15a to learn a measuring error, the position correcting unit 21 makes a learning weight for the position of the host vehicle measured by the host vehicle position measuring unit 12 before the change in the position becomes equal to or larger than the threshold lower than a learning weight for the position of the host vehicle measured by the host vehicle position measuring unit 12 after the change in the position becomes equal to or larger than the threshold. The threshold may be stored in an internal memory of the position correcting unit 21 or may be supplied from the outside of the host vehicle position measuring device 3.

In FIG. 19, it is assumed that each of the first feature position detecting unit 11, the host vehicle position measuring unit 12, the second feature position detecting unit 13, the error calculating unit 14, the learning model storing unit 15, and the position correcting unit 21, which are constituent elements of the host vehicle position measuring device 3, is implemented by dedicated hardware as illustrated in FIG. 20. That is, it is assumed that the host vehicle position measuring device 3 is implemented by the first feature position detecting circuit 31, the host vehicle position measuring circuit 32, the second feature position detecting circuit 33, the error calculating circuit 34, the learning model storing circuit 35, and the position correcting circuit 41.

To each of the first feature position detecting circuit 31, the host vehicle position measuring circuit 32, the second feature position detecting circuit 33, the error calculating circuit 34, and the position correcting circuit 41, a single circuit, a composite circuit, a programmed processor, a parallel programmed processor, ASIC, FPGA, or a combination thereof corresponds.

The constituent elements of the host vehicle position measuring device 3 are not limited to those implemented by dedicated hardware, and the host vehicle position measuring device 3 may be implemented by software, firmware, or a combination of software and firmware.

In a case where the host vehicle position measuring device 3 is implemented by software, firmware, or the like, the learning model storing unit 15 is constituted on the memory 51 illustrated in FIG. 3. A program for causing a computer to execute a processing procedure performed in each of the first feature position detecting unit 11, the host vehicle position measuring unit 12, the second feature position detecting unit 13, the error calculating unit 14, and the position correcting unit 21 is stored in the memory 51. Then, the processor 52 illustrated in FIG. 3 executes the program stored in the memory 51.

FIG. 20 illustrates an example in which each of the constituent elements of the host vehicle position measuring device 3 is implemented by dedicated hardware, and FIG. 3 illustrates an example in which the host vehicle position measuring device 3 is implemented by software, firmware, or the like. However, this is only an example, and some constituent elements in the host vehicle position measuring device 3 may be implemented by dedicated hardware, and the remaining constituent elements may be implemented by software, firmware, or the like.

Next, an operation of the host vehicle position measuring device 3 illustrated in FIG. 19 will be described. Since the units other than the position correcting unit 21 are similar to those of the host vehicle position measuring device 3 illustrated in FIG. 1, only an operation of the position correcting unit 21 will be described here.

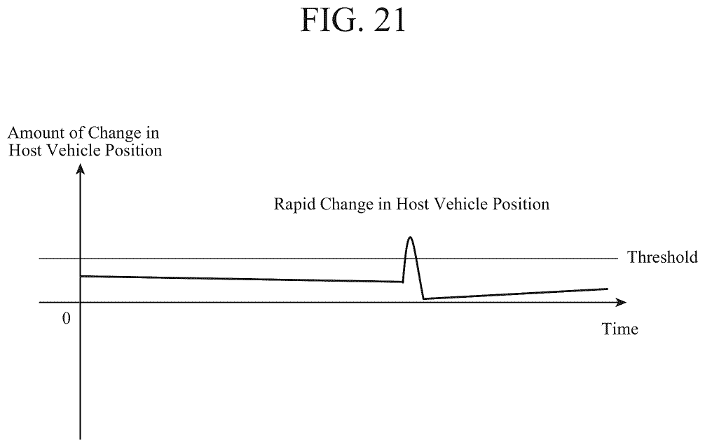

FIG. 21 is an explanatory diagram illustrating a change in the position of the host vehicle measured by the host vehicle position measuring unit 12.

In FIG. 21, the horizontal axis represents time, and the vertical axis represents the amount of change in the position of the host vehicle measured by the host vehicle position measuring unit 12.

The position correcting unit 21 monitors a change in the position of the host vehicle measured by the host vehicle position measuring unit 12. When the position of the host vehicle rapidly changes, the amount of change in the position may be equal to or larger than a threshold as illustrated in FIG. 21.

In a case where the position of the host vehicle rapidly changes, behavior of the measuring error before the position of the host vehicle rapidly changes is often different from behavior of the measuring error after the position of the host vehicle rapidly changes. Therefore, when the learning model 15a is caused to learn the measuring error, it is desirable to reduce an influence of the position of the host vehicle measured by the host vehicle position measuring unit 12 before the position of the host vehicle rapidly changes.

When the time at which the amount of change in the position is equal to or larger than the threshold is tₖ, at the time of causing the learning model 15a to learn a measuring error, the position correcting unit 21 causes the learning model 15a to perform learning in such a manner that a learning weight for the position of the host vehicle measured by the host vehicle position measuring unit 12 at a time tₖ₋₁ is lower than a learning weight for the position of the host vehicle measured by the host vehicle position measuring unit 12 at a time tₖ-pi.

As a result, the influence of the position of the host vehicle at the time tₖ₋₁ is reduced in the learning of the learning model 15a.

In the above fifth embodiment, the host vehicle position measuring device 3 illustrated in FIG. 19 is configured in such a manner that, when a change in the position of the host vehicle measured by the host vehicle position measuring unit 12 is equal to or larger than a threshold, at the time of causing the learning model 15a to learn a measuring error, the position correcting unit 21 makes a learning weight for the position of the host vehicle measured by the host vehicle position measuring unit 12 before the change in the position becomes equal to or larger than the threshold lower than a learning weight for the position of the host vehicle measured by the host vehicle position measuring unit 12 after the change in the position becomes equal to or larger than the threshold. Therefore, similarly to the host vehicle position measuring device 3 illustrated in FIG. 1, the host vehicle position measuring device 3 illustrated in FIG. 19 can improve host vehicle position measuring accuracy even in a situation where a position of a feature present around the host vehicle cannot be detected, on the basis of sensor information from the in-vehicle sensor 1. In addition, the host vehicle position measuring device 3 illustrated in FIG. 19 can reduce an influence on learning of the learning model 15a even when the position of the host vehicle measured by the host vehicle position measuring unit 12 rapidly changes.

In the host vehicle position measuring device 3 illustrated in FIG. 19, at the time of causing the learning model 15a to learn a measuring error, the position correcting unit 21 lowers a learning weight for the position of the host vehicle measured by the host vehicle position measuring unit 12 at the time tₖ₋₁. However, this is merely an example, and at the time of causing the learning model 15a to learn the measuring error, the position correcting unit 21 may reduce the number of pieces of position data indicating the position of the host vehicle measured by the host vehicle position measuring unit 12 before the change in the position becomes equal to or larger than the threshold.

In a case where the error estimating model is the state space model 17a as in the host vehicle position measuring device 3 illustrated in FIG. 10, when the time at which the amount of change in the position becomes equal to or larger than the threshold is tₖ, the position correcting unit 18 may lower a weight of an observation value Yₖ by increasing a value of the Kalman gain Gₖ at the time of calculating a state value Xₖ and reducing an influence of a state equation.

In the host vehicle position measuring device 3 illustrated in FIG. 13, when the time at which the amount of change in the position becomes equal to or larger than the threshold is tₖ, the position correcting unit 19 does not have to use a measuring error at a time before the time tₖ.

In the host vehicle position measuring device 3 illustrated in FIG. 16, when the time at which the amount of change in the position becomes equal to or larger than the threshold is tₖ, the position correcting unit 20 may calculate an average value without using a measuring error at a time before the time tₖ.

### Sixth Embodiment

In a sixth embodiment, a host vehicle position measuring device 3 including a surrounding environment detecting unit 22 that detects a surrounding environment of a host vehicle will be described.

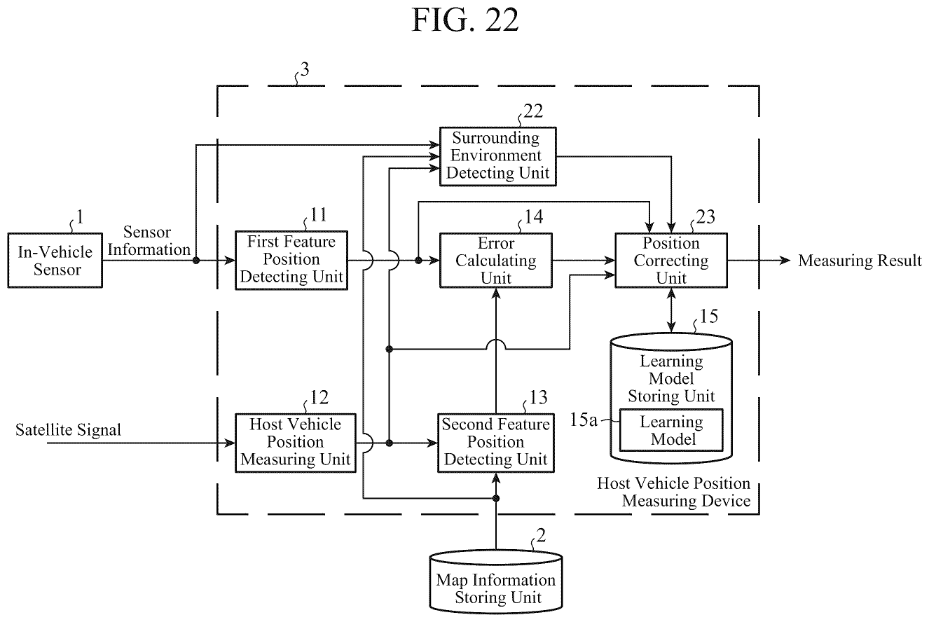

FIG. 22 is a configuration diagram illustrating the host vehicle position measuring device 3 according to the sixth embodiment. In FIG. 22, the same reference numerals as in FIG. 1 indicate the same or corresponding parts, and therefore description thereof is omitted.

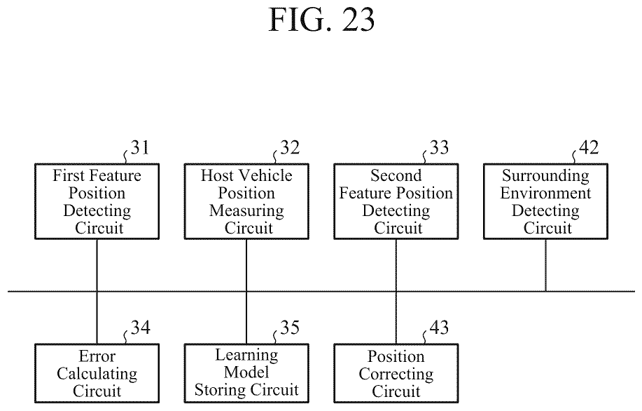

FIG. 23 is a hardware configuration diagram illustrating hardware of the host vehicle position measuring device 3 according to the sixth embodiment. In FIG. 23, the same reference numerals as in FIG. 2 indicate the same or corresponding parts, and therefore description thereof is omitted.

The host vehicle position measuring device 3 illustrated in FIG. 22 includes a first feature position detecting unit 11, a host vehicle position measuring unit 12, a second feature position detecting unit 13, an error calculating unit 14, a learning model storing unit 15, the surrounding environment detecting unit 22, and a position correcting unit 23.

The surrounding environment detecting unit 22 is implemented by, for example, a surrounding environment detecting circuit 42 illustrated in FIG. 23.

The surrounding environment detecting unit 22 acquires sensor information from an in-vehicle sensor 1, and detects a surrounding environment of a host vehicle on the basis of the sensor information.

The surrounding environment detecting unit 22 outputs a detection result of the surrounding environment to the position correcting unit 23.

The position correcting unit 23 is implemented by, for example, a position correcting circuit 43 illustrated in FIG. 23.

Position correcting processing performed by the position correcting unit 23 is similar to the position correcting processing performed by the position correcting unit 16 illustrated in FIG. 1.

Similarly to the position correcting unit 16 illustrated in FIG. 1, the position correcting unit 23 calculates the reliability R of position detection performed by the first feature position detecting unit 11.

Similarly to the position correcting unit 16 illustrated in FIG. 1, the position correcting unit 23 supplies learning data including host vehicle position data indicating the position of the host vehicle measured by the host vehicle position measuring unit 12 and error data indicating an error calculated by the error calculating unit 14 to the learning model 15a.

Similarly to the position correcting unit 16 illustrated in FIG. 1, the position correcting unit 23 causes the learning model 15a to learn a measuring error using the error indicated by the error data included in the learning data as the measuring error.

At the time of causing the learning model 15a to learn the measuring error, the position correcting unit 23 changes a learning weight for the error calculated by the error calculating unit 14 on the basis of the detection result of the surrounding environment by the surrounding environment detecting unit 22.

In FIG. 22, it is assumed that each of the first feature position detecting unit 11, the host vehicle position measuring unit 12, the second feature position detecting unit 13, the error calculating unit 14, the learning model storing unit 15, the surrounding environment detecting unit 22, and the position correcting unit 23, which are constituent elements of the host vehicle position measuring device 3, is implemented by dedicated hardware as illustrated in FIG. 23. That is, it is assumed that the host vehicle position measuring device 3 is implemented by the first feature position detecting circuit 31, the host vehicle position measuring circuit 32, the second feature position detecting circuit 33, the error calculating circuit 34, the learning model storing circuit 35, the surrounding environment detecting circuit 42, and the position correcting circuit 43.

To each of the first feature position detecting circuit 31, the host vehicle position measuring circuit 32, the second feature position detecting circuit 33, the error calculating circuit 34, the surrounding environment detecting circuit 42, and the position correcting circuit 43, a single circuit, a composite circuit, a programmed processor, a parallel programmed processor, ASIC, FPGA, or a combination thereof corresponds.

The constituent elements of the host vehicle position measuring device 3 are not limited to those implemented by dedicated hardware, and the host vehicle position measuring device 3 may be implemented by software, firmware, or a combination of software and firmware.

In a case where the host vehicle position measuring device 3 is implemented by software, firmware, or the like, the learning model storing unit 15 is constituted on the memory 51 illustrated in FIG. 3. A program for causing a computer to execute a processing procedure performed in each of the first feature position detecting unit 11, the host vehicle position measuring unit 12, the second feature position detecting unit 13, the error calculating unit 14, the surrounding environment detecting unit 22, and the position correcting unit 23 is stored in the memory 51. Then, the processor 52 illustrated in FIG. 3 executes the program stored in the memory 51.

FIG. 23 illustrates an example in which each of the constituent elements of the host vehicle position measuring device 3 is implemented by dedicated hardware, and FIG. 3 illustrates an example in which the host vehicle position measuring device 3 is implemented by software, firmware, or the like. However, this is only an example, and some constituent elements in the host vehicle position measuring device 3 may be implemented by dedicated hardware, and the remaining constituent elements may be implemented by software, firmware, or the like.

Next, an operation of the host vehicle position measuring device 3 illustrated in FIG. 22 will be described. The operation of the host vehicle position measuring device 3 illustrated in FIG. 22 is similar to that of the host vehicle position measuring device 3 illustrated in FIG. 1 except for the surrounding environment detecting unit 22 and the position correcting unit 23. Therefore, here, operations of the surrounding environment detecting unit 22 and the position correcting unit 23 will be described.

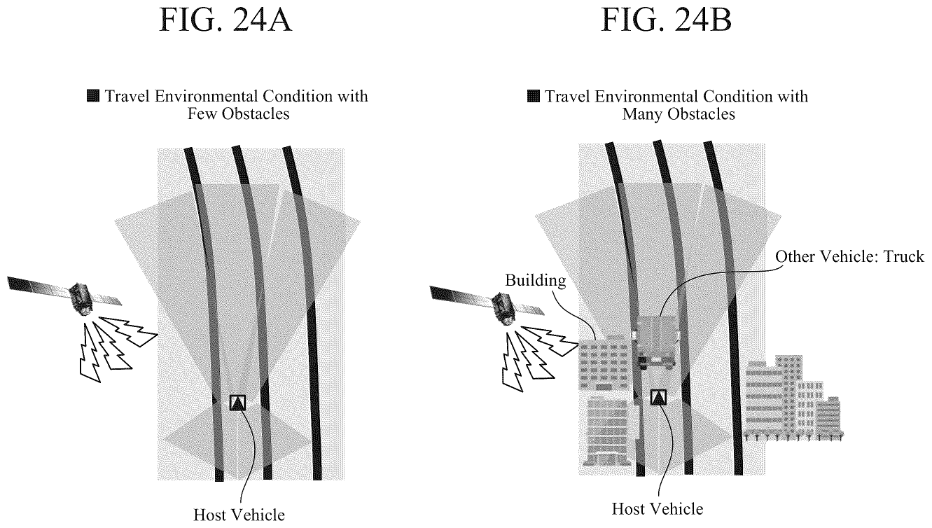

FIG. 24A is an explanatory diagram illustrating a travel environmental condition with few obstacles. FIG. 24B is an explanatory diagram illustrating a travel environmental condition with many obstacles.

In the example of FIG. 24A, since there is no obstacle such as a building blocking a satellite signal emitted from a satellite between the satellite and the host vehicle, the travel environmental condition has few obstacles.

In the example of FIG. 24B, since there is an obstacle such as a building blocking a satellite signal emitted from a satellite between the satellite and the host vehicle, the travel environmental condition has many obstacles.

The surrounding environment detecting unit 22 acquires sensor information from an in-vehicle sensor 1, and detects a surrounding environment of a host vehicle on the basis of the sensor information.

The surrounding environment detecting unit 22 outputs a detection result of the surrounding environment to the position correcting unit 23. The detection result of the surrounding environment indicates whether or not there is an obstacle such as a building blocking a satellite signal emitted from a satellite between the satellite and the host vehicle.

When the satellite signal emitted from the satellite is, for example, a global positioning system (GPS) signal, the surrounding environment detecting unit 22 can check the three-dimensional position of the satellite by referring to the GPS signal.

The surrounding environment detecting unit 22 draws a line segment connecting the three-dimensional position of the satellite and the three-dimensional position of the host vehicle indicated by the host vehicle position data output from the host vehicle position measuring unit 12, and determines that there is an obstacle between the satellite and the host vehicle when there is a building or the like blocking the line segment.

When there is no building or the like blocking the line segment, the surrounding environment detecting unit 22 determines that there is no obstacle between the satellite and the host vehicle.

The surrounding environment detecting unit 22 refers to map information stored in a map information storing unit 2 and acquires attribute information of a building or the like present around the host vehicle. The attribute information is information indicating the size, shape, color, and the like of the building or the like.

The surrounding environment detecting unit 22 can check the three-dimensional position of a space occupied by the building or the like by referring to the attribute information of the building or the like.

At the time of causing the learning model 15a to learn the measuring error, the position correcting unit 23 changes a learning weight for the error calculated by the error calculating unit 14 on the basis of the detection result of the surrounding environment by the surrounding environment detecting unit 22.

Specifically, in a case where there is an obstacle around the host vehicle, there is a possibility that a position measuring error in the host vehicle position measuring unit 12 is large, and as a result, there is a possibility that error calculating accuracy by the error calculating unit 14 is deteriorated.

Therefore, in a case where the detection result of the surrounding environment by the surrounding environment detecting unit 22 indicates that there is an obstacle, the position correcting unit 23 changes the learning weight for the error calculated by the error calculating unit 14 to be smaller than the learning weight for the error in a case where the detection result does not indicate that there is an obstacle.

As a result, in the learning of the learning model 15a, an influence of radio wave obstruction due to an obstacle present around the host vehicle is reduced.

In the above sixth embodiment, the host vehicle position measuring device 3 illustrated in FIG. 22 is configured to include the surrounding environment detecting unit 22 that acquires sensor information from the in-vehicle sensor 1 and detects a surrounding environment of the host vehicle on the basis of the sensor information. In addition, in the host vehicle position measuring device 3 illustrated in FIG. 22, at the time of causing the learning model 15a to learn the measuring error, the position correcting unit 23 changes the learning weight for the error calculated by the error calculating unit 14 on the basis of the detection result of the surrounding environment by the surrounding environment detecting unit 22. Therefore, similarly to the host vehicle position measuring device 3 illustrated in FIG. 1, the host vehicle position measuring device 3 illustrated in FIG. 22 can improve host vehicle position measuring accuracy even in a situation where a position of a feature present around the host vehicle cannot be detected, on the basis of sensor information from the in-vehicle sensor 1. In addition, the host vehicle position measuring device 3 illustrated in FIG. 22 can reduce an influence of radio wave obstruction on learning of the learning model 15a in a case where there is an obstacle around the host vehicle.

In the host vehicle position measuring devices 3 according to the first to sixth embodiments, the position correcting unit 16 or the like corrects each of the position of the host vehicle in a traveling direction and the position of the host vehicle in a vehicle width direction as the position of the host vehicle.

However, this is merely an example, and the position correcting unit 16 or the like may correct only the position of the host vehicle in the vehicle width direction. For example, under a situation where there is no change in the shape of a road on which the host vehicle travels, it may be difficult to detect a relative position in the vehicle traveling direction with high accuracy. In such a case, the first feature position detecting unit 11 detects only the relative position in the vehicle lateral direction which is the vehicle width direction, and the error calculating unit 14 calculates only an error in the vehicle lateral direction. The position correcting unit 16 or the like corrects only the position of the host vehicle in the vehicle width direction.

Note that the present disclosure can freely combine the embodiments to each other, modify any constituent element in each of the embodiments, or omit any constituent element in each of the embodiments.

### REFERENCE SIGNS LIST

1: in-vehicle sensor, 2: map information storing unit, 3: host vehicle position measuring device, 11: first feature position detecting unit, 12: host vehicle position measuring unit, 13: second feature position detecting unit, 14: error calculating unit, 15: learning model storing unit, 15a: learning model, 16: position correcting unit, 17: state space model storing unit, 17a: state space model, 18: position correcting unit, 19: position correcting unit, 20: position correcting unit, 21: position correcting unit, 22: surrounding environment detecting unit, 23: position correcting unit, 31: first feature position detecting circuit, 32: host vehicle position measuring circuit, 33: second feature position detecting circuit, 34: error calculating circuit, 35: learning model storing circuit, 36: position correcting circuit, 37: state space model storing circuit, 38: position correcting circuit, 39: position correcting circuit, 40: position correcting circuit, 41: position correcting circuit, 42: surrounding environment detecting circuit, 43: position correcting circuit, 51: memory, 52: processor

1. A host vehicle position measuring device comprising:
processing circuitry configured to
measure a position of a host vehicle using a satellite signal emitted from a satellite positioning system; and
estimate, using an error estimating model for estimating a position measuring error, a measuring error corresponding to the measured position of the host vehicle, and correct the measured position of the host vehicle using the measuring error.

2. The host vehicle position measuring device according to claim 1, wherein
the error estimating model is a learning model in which the position measuring error has been learned, and
the processing circuitry supplies position data indicating the measured position of the host vehicle to the learning model, acquires measuring error data indicating a measuring error corresponding to the position indicated by the position data from the learning model, and corrects the measured position of the host vehicle using the measuring error.

3. The host vehicle position measuring device according to claim 2,
wherein the processing circuitry is further configured to
acquire sensor information from an in-vehicle sensor that observes surroundings of the host vehicle and to detect a first relative position of a feature present around the host vehicle with respect to the host vehicle on a basis of the sensor information;
detect a second relative position of the feature with respect to the host vehicle on a basis of the measured position of the host vehicle and map information; and
calculate an error between the first relative position and the second relative position, wherein
calculates a reliability of position detection, and
when the reliability is equal to or larger than an allowable reliability, the processing circuitry supplies learning data including the position data indicating the measured position of the host vehicle and error data indicating a calculated error to the learning model, and causes the learning model to learn a measuring error using the error indicated by the error data as the measuring error, and
when the calculated reliability is smaller than the allowable reliability, the processing circuitry supplies the position data indicating the measured position of the host vehicle to the learning model, acquires measuring error data indicating a measuring error corresponding to the position indicated by the position data from the learning model, and corrects the measured position of the host vehicle using the measuring error.

4. The host vehicle position measuring device according to claim 3, wherein
when the calculated reliability is equal to or larger than the allowable reliability, the processing circuitry outputs, as a position measuring result, position data indicating the measured position of the host vehicle, and when the calculated reliability is smaller than the allowable reliability, the processing circuitry outputs, as a position measuring result, position data indicating the corrected position.

5. The host vehicle position measuring device according to claim 1, wherein
the error estimating model is a state space model indicating a state equation of a position measuring error, and
the processing circuitry calculates a measuring error by putting the measured position of the host vehicle into the state equation, and corrects the measured position of the host vehicle using the measuring error.

6. The host vehicle position measuring device according to claim 3, wherein
the processing circuitry calculates a position measuring error by putting a time at which an error is calculated into an approximate function indicating a measuring error corresponding to a time, supplies learning data including the position data indicating the measured position of the host vehicle and error data indicating the calculated measuring error to the learning model and causes the learning model to learn the measuring error.

7. The host vehicle position measuring device according to claim 3, wherein
the processing circuitry calculates, as a position measuring error, an average value of calculated errors at a plurality of times, supplies learning data including the position data indicating the measured position of the host vehicle and the average value to the learning model and causes the learning model to learn the average value.

8. The host vehicle position measuring device according to claim 3, wherein
when a change in the measured position of the host vehicle is equal to or larger than a threshold, at the time of causing the learning model to learn the measuring error, the processing circuitry reduces a learning weight for the measured position of the host vehicle before the change in the position becomes equal to or larger than the threshold, with respect to a learning weight for the measured position of the host vehicle after the change in the position becomes equal to or larger than the threshold.

9. The host vehicle position measuring device according to claim 3,
wherein the processing circuitry is further configured to
acquire sensor information from the in-vehicle sensor and to detect a surrounding environment of the host vehicle on a basis of the sensor information, wherein
at the time of causing the learning model to learn the measuring error, the processing circuitry changes a learning weight for the calculated error on a basis of a detection result of the surrounding environment.

10. The host vehicle position measuring device according to claim 1, wherein
the processing circuitry estimates, as a measuring error corresponding to the measured position of the host vehicle, a measuring error of the host vehicle in a vehicle width direction orthogonal to the vehicle traveling direction using the error estimating model, and corrects the measured position of the host vehicle in the vehicle width direction using the measuring error in the vehicle width direction.

11. The host vehicle position measuring device according to claim 1, wherein
the processing circuitry acquires vehicle speed information indicating a speed of the host vehicle, steering angle information indicating a steering angle of the host vehicle, or relative position information indicating a relative position between the measured position of the host vehicle and the position of the satellite in the satellite positioning system, estimates measuring errors corresponding to the measured position of the host vehicle and the speed indicated by the vehicle speed information, the steering angle indicated by the steering angle information, or the relative position indicated by the relative position information using the error estimating model, and corrects the measured position of the host vehicle using the measuring error.

12. A host vehicle position measuring method comprising:
measuring a position of a host vehicle using a satellite signal emitted from a satellite positioning system; and
estimating a measuring error corresponding to the measured position of the host vehicle using an error estimating model for estimating a position measuring error; and
correcting the measured position of the host vehicle using the measuring error.
